(19) United States
(12) Patent Application Publication
(10) Pub. No.: US 2019/0021123 A1
(43) Pub. Date: Jan. 17, 2019

(54) SECURITY PARAMETER TRANSMISSION METHOD AND RELATED DEVICE

(71) Applicant: HUAWEI TECHNOLOGIES CO., LTD., Shenzhen (CN)

(72) Inventors: Jie MA, Shenzhen (CN); Bo LIN, Beijing (CN)

(21) Appl. No.: 16/045,572

(22) Filed: Jul. 25, 2018

Related U.S. Application Data
(63) Continuation of application No. PCT/CN2016/073566, filed on Feb. 4, 2016.

(51) Int. Cl. H04W 76/11; H04B 7/155; H04W 12/04

(52) U.S. Cl. CPC H04W 76/11; H04W 12/10; H04W 12/04; H04B 7/155

(57) ABSTRACT

A security parameter transmission method and related devices are disclosed for resolving a transmission problem of a security parameter required for secure communication between a remote device and a cellular network. For the method, a radio resource connection signaling is received by a network side device, which is sent by a first terminal device. The first terminal device implements a relay function, and the radio resource connection management signaling is sent by a second terminal device to the first terminal device. An identifier of the second terminal device that generates the radio resource connection management signaling is determined, and obtains a security parameter corresponding to the identifier of the second terminal device. The network side device sends the obtained security parameter to the second terminal device by using the first terminal device.

### CROSS-REFERENCE TO RELATED APPLICATIONS

This application is a continuation of International Application No. PCT/CN2016/073566, filed on Feb. 4, 2016, the disclosure of which is hereby incorporated by reference in its entirety.

### TECHNICAL FIELD

The present invention relates to the field of communication technologies, and, in particular, to a security parameter transmission method and a related device.

### BACKGROUND

Device-to-device (D2D) communication refers to devices that directly communicate with each other. Exemplary D2D deployment scenarios are shown in FIGS. 1 to 4. When a communication distance in a D2D communication mode is limited, and a terminal (UE) located outside coverage of a network cannot establish a connection to the network, communication between the terminal and the network can be affected. When the terminal is located outside the coverage of the network, but is relatively close to the coverage of the network, a terminal within the coverage of the network may be found and used as a relay to establish the connection to the network. As shown in FIG. 5, when UE B is located outside the coverage of the network, the UE B may establish a connection to the network by using UE A within the coverage of the network. The UE A providing a relay service is referred to as relay user equipment (Relay UE) or a relay terminal, and the UE B is referred to as remote user equipment (Remote UE) or a remote terminal, that is, user equipment or a terminal located outside the coverage of the network.

Currently, wearable equipment (WE) mainly communicates with a smartphone by using a D2D protocol. Generally, the wearable equipment communicates with the smartphone by using a Bluetooth technology or a Wireless Fidelity (Wi-Fi) technology, and interaction information between the wearable equipment and the smartphone is invisible to the network. However, in many cases, the wearable equipment may be far away from the smartphone, but could be capable of a direct cellular network connection mode, that is, the wearable equipment can access a cellular network by using a nearby relay UE providing a relay service.

Because wearable equipment can contain private user information, improvements are needed for secure communication between the wearable equipment in direct cellular connection mode and a cellular network .

### SUMMARY

Embodiments are disclosed that provide a security parameter transmission method and a related device for secure communication between a remote device and a cellular network.

According to one embodiment, a security parameter transmission method includes:

receiving, by a network side device, radio resource connection management signaling sent by a first terminal device, where the first terminal device implements a relay function, and the radio resource connection management signaling is sent by a second terminal device to the first terminal device;

determining, by the network side device, an identifier of the second terminal device that generates the radio resource connection management signaling, and obtaining a security parameter corresponding to the identifier of the second terminal device; and

sending, by the network side device, the obtained security parameter to the second terminal device by using the first terminal device.

For this embodiment, after receiving, by using the first terminal device with a relay function, the radio resource connection management signaling that is used to request to obtain the security parameter, the network side device determines the identifier of the second terminal device that generates the radio resource connection management signaling. The network side devices obtains the security parameter corresponding to the identifier of the second terminal device, and sends the obtained security parameter to the second terminal device by using the first terminal device. In this way, the network side device configures the security parameter for the second terminal device in a manner of forwarding signaling by using the first terminal device.

For one embodiment, the radio resource connection management signaling includes the identifier of the second terminal device.

For one embodiment, the determining, by the network side device, an identifier of the second terminal device that generates the radio resource connection management signaling includes:

determining, by the network side device, an identifier of a dedicated radio bearer for transmitting the radio resource connection management signaling, and determining, based on a correspondence between an identifier of a dedicated radio bearer and an identifier of a second terminal device, that an identifier of a second terminal device corresponding to the identifier of the dedicated radio bearer for transmitting the radio resource connection management signaling is the identifier of the second terminal device that generates the radio resource connection management signaling, where the dedicated radio bearer is a radio bearer between the network side device and the first terminal device; or

obtaining, by the network side device, signaling source indication information included in the radio resource connection management signaling, determining, based on the signaling source indication information, that the radio resource connection management signaling is generated by the second terminal device, and determining the identifier of the second terminal device based on the radio resource connection management signaling, where the signaling source indication information is used to indicate that the radio resource connection management signaling is generated by the second terminal device.

For this embodiment, the network side device can distinguish signaling of the first terminal device from signaling of the second terminal device.

For one embodiment, before the receiving, by a network side device, radio resource connection management signaling sent by a first terminal device, the method further includes:

sending, by the network side device, radio bearer configuration signaling to the first terminal device, where the radio bearer configuration signaling includes at least the identifier of the dedicated radio bearer that is to be configured for transmitting the radio resource connection management signaling of the second terminal device; and

receiving, by the network side device, radio bearer configuration complete signaling returned by the first terminal device, where the radio bearer configuration complete signaling is used to indicate that configuration of the dedicated radio bearer for transmitting the radio resource connection management signaling of the second terminal device is completed.

For this embodiment, a dedicated radio bearer for forwarding signaling of the second terminal device can be set up between the first terminal device and the network side device.

For one embodiment, the sending, by the network side device, the obtained security parameter to the second terminal device by using the first terminal device includes:

generating, by the network side device, a secure transmission mode request, where the secure transmission mode request includes the security parameter; and

sending, by the network side device, the secure transmission mode request to the first terminal device, wherein the first terminal device forwards the secure transmission mode request to the second terminal device.

For this embodiment, the network side device can use the first terminal device as a relay to forward the security parameter to the second terminal device.

For one embodiment, an attribute of a dedicated radio bearer carrying the secure transmission mode request includes the identifier of the second terminal device, the dedicated radio bearer is a radio bearer between the network side device and the first terminal device, and the first terminal device forwards the secure transmission mode request to the second terminal device based on the identifier of the second terminal device included in the attribute of the dedicated radio bearer; or

the secure transmission mode request further includes the identifier of the second terminal device, and the first terminal device forwards the secure transmission mode request to the second terminal device based on the identifier of the second terminal device carried in the secure transmission mode request.

For this embodiment, the first terminal device can distinguish whether signaling sent by the network side device belongs to the first terminal device or the signaling needs to be relayed to the second terminal device.

For one embodiment, when the security parameter is used to transmit data between the second terminal device and the network side device, encryption and/or decryption and/or integrity protection and/or integrity protection check are/is performed on the data.

According to one embodiment a security parameter transmission method includes:

determining, by a first terminal device, that a destination of radio resource connection management signaling of a second terminal device is a network side device, and then sending the radio resource connection management signaling to the network side device, wherein the first terminal device implements a relay function; and

receiving, by the first terminal device, a security parameter returned by the network side device based on the radio resource connection management signaling, and forwarding the security parameter to the second terminal device, where the security parameter is obtained by the network side device based on an identifier of the second terminal device after the network side device determines the identifier of the second terminal device that generates the radio resource connection management signaling.

For this embodiment, the first terminal device uses the relay function to forward the security parameter of the second terminal device from the network side device to the second terminal device.

For one embodiment, the radio resource connection management signaling carries the identifier of the second terminal device.

For one embodiment, the determining, by a first terminal device, that a destination of radio resource connection management signaling of a second terminal device is a network side device includes:

if determining to receive, by using a dedicated air interface resource, the radio resource connection management signaling sent by the second terminal device, determining, by the first terminal device, that the destination of the radio resource connection management signaling is the network side device, where the dedicated air interface resource is used to instruct the first terminal device to forward signaling of the second terminal device to the network side device; or

determining, by the first terminal device, that the radio resource connection management signaling carries forwarding instruction information, and determining, based on the forwarding instruction information, that the destination of the radio resource connection management signaling is the network side device, where the forwarding instruction information is used to instruct to forward signaling of the second terminal device to the network side device.

For this embodiment, the first terminal device can distinguish signaling whose destination is the first terminal device from signaling whose destination is the network side device, and directly forward signaling that is from the second terminal device and whose destination is the network side device.

For one embodiment, the sending, by a first terminal device, the radio resource connection management signaling to the network side device includes:

determining, by the first terminal device based on a correspondence between an identifier of a second terminal device and an identifier of a dedicated radio bearer, an identifier of a dedicated radio bearer corresponding to the identifier of the second terminal device that generates the radio resource connection management signaling, and sending the radio resource connection management signaling to the network side device based on the identifier of the dedicated radio bearer, where the dedicated radio bearer is a radio bearer between the network side device and the first terminal device; or

sending, by the first terminal device, the radio resource connection management signaling to the network side device after adding signaling source indication information to the radio resource connection management signaling, where the signaling source indication information is used to indicate that the radio resource connection management signaling is generated by the second terminal device.

For this embodiment, the network side device can distinguish signaling of the first terminal device from signaling of the second terminal device.

For one embodiment, before the determining, by the first terminal device based on a correspondence between an identifier of a second terminal device and an identifier of a dedicated radio bearer, an identifier of a dedicated radio bearer corresponding to the identifier of the second terminal device that generates the radio resource connection management signaling, the method further includes:

receiving, by the first terminal device, radio bearer configuration signaling sent by the network side device, where the radio bearer configuration signaling includes at least the identifier of the dedicated radio bearer that is to be configured for transmitting the radio resource connection management signaling of the second terminal device; and

returning, by the first terminal device, radio bearer configuration complete signaling to the network side device after configuring, based on the radio bearer configuration signaling, the dedicated radio bearer for forwarding the radio resource connection management signaling of the second terminal device, where the radio bearer configuration complete signaling is used to indicate that configuration of the dedicated radio bearer for transmitting the radio resource connection management signaling of the second terminal device is completed.

For this embodiment, a dedicated radio bearer for forwarding signaling of the second terminal device can be set up between the first terminal device and the network side device.

For one embodiment, the receiving, by the first terminal device, a security parameter returned by the network side device based on the radio resource connection management signaling, and forwarding the security parameter to the second terminal device includes:

receiving, by the first terminal device, a secure transmission mode request returned by the network side device, where the secure transmission mode request includes the security parameter; and

forwarding, by the first terminal device, the secure transmission mode request to the second terminal device.

For this embodiment, the network side device can use the first terminal device as a relay to forward the security parameter to the second terminal device.

For one embodiment, the forwarding, by the first terminal device, the secure transmission mode request to the second terminal device includes:

determining, by the first terminal device, the identifier of the second terminal device included in an attribute of a dedicated radio bearer carrying the secure transmission mode request, where the dedicated radio bearer is a radio bearer between the network side device and the first terminal device; and forwarding the secure transmission mode request to the second terminal device based on the identifier of the second terminal device included in the attribute of the dedicated radio bearer; or

if the secure transmission mode request further carries the identifier of the second terminal device, forwarding, by the first terminal device, the secure transmission mode request to the second terminal device based on the identifier of the second terminal device carried in the secure transmission mode request.

For this embodiment, the first terminal device can distinguish whether signaling sent by the network side device belongs to the first terminal device or the signaling needs to be relayed to the second terminal device.

For one embodiment, the first terminal device and the second terminal device establish a wireless connection with each other by using a device-to-device D2D protocol, a Bluetooth protocol, or a Wireless Fidelity Wi-Fi protocol.

According to one embodiment a security parameter transmission method includes:

sending, by a second terminal device, radio resource connection management signaling to a first terminal device, wherein the first terminal device forwards the radio resource connection management signaling to a network side device after determining that a destination of the radio resource connection management signaling is the network side device, wherein the first terminal device implements a relay function; and

receiving, by the second terminal device, a security parameter returned by the network side device by using the first terminal device, wherein the security parameter is obtained by the network side device based on an identifier of the second terminal device after the network side device determines the identifier of the second terminal device that generates the radio resource connection management signaling.

For this embodiment, the second terminal device uses the relay function of the first terminal device to obtain the security parameter from the network side device.

For one embodiment, the radio resource connection management signaling carries the identifier of the second terminal device.

For one embodiment, the sending, by a second terminal device, radio resource connection management signaling to a first terminal device includes:

sending, by the second terminal device, the radio resource connection management signaling to the first terminal device by using a dedicated air interface resource, wherein the dedicated air interface resource is used to instruct to forward signaling of the second terminal device to the network side device; or

sending, by the second terminal device, the radio resource connection management signaling to the first terminal device after adding forwarding instruction information to the radio resource connection management signaling, wherein the forwarding instruction information is used to instruct to forward signaling of the second terminal device to the network side device.

For one embodiment, the first terminal device and the second terminal device establish a wireless connection with each other by using a device-to-device D2D protocol, a Bluetooth protocol, or a Wireless Fidelity Wi-Fi protocol.

According to one embodiment a method for setting up a radio bearer for security parameter transmission includes:

sending, by a network side device, radio bearer configuration signaling to a first terminal device, wherein the radio bearer configuration signaling includes at least an identifier of a dedicated radio bearer that is to be configured for transmitting radio resource connection management signaling of a second terminal device, the dedicated radio bearer is a radio bearer between the network side device and the first terminal device, and the first terminal device implements a relay function; and

receiving, by the network side device, radio bearer configuration complete signaling returned by the first terminal device, where the radio bearer configuration complete signaling is used to indicate that configuration of the dedicated radio bearer for transmitting the radio resource connection management signaling of the second terminal device is completed.

For one embodiment, the radio bearer configuration signaling further includes any one or a combination of the following:

relay indication information, used to indicate that the to-be-configured dedicated radio bearer is used to relay data of the second terminal device;

a second terminal device identifier or a second terminal device identifier list, used to indicate that the to-be-configured dedicated radio bearer is used to transmit data of a second terminal device indicated by the second terminal device identifier or the second terminal device identifier list;

a configuration parameter of a radio link control layer;

Medium Access Control MAC configuration information, used to indicate a logical channel group of the to-be-configured dedicated radio bearer; and

a temporary cell radio network temporary identifier CRNTI list.

According to one embodiment a method for setting up a radio bearer for security parameter transmission includes:

receiving, by a first terminal device, radio bearer configuration signaling sent by a network side device, wherein the radio bearer configuration signaling includes at least an identifier of a dedicated radio bearer that is to be configured for transmitting radio resource connection management signaling of a second terminal device, the dedicated radio bearer is a radio bearer between the network side device and the first terminal device, and the first terminal device has a relay function; and

returning, by the first terminal device, radio bearer configuration complete signaling to the network side device after configuring, based on the radio bearer configuration signaling, the dedicated radio bearer for forwarding the radio resource connection management signaling of the second terminal device, wherein the radio bearer configuration complete signaling is used to indicate that configuration of the dedicated radio bearer for transmitting the radio resource connection management signaling of the second terminal device is completed.

For one embodiment, the radio bearer configuration signaling further includes any one or a combination of the following:

relay indication information, used to indicate that the to-be-configured dedicated radio bearer is used to relay data of the second terminal device;

a second terminal device identifier or a second terminal device identifier list, used to indicate that the to-be-configured dedicated radio bearer is used to transmit data of a second terminal device indicated by the second terminal device identifier or the second terminal device identifier list;

a configuration parameter of a radio link control layer;

Medium Access Control MAC configuration information, used to indicate a logical channel group of the to-be-configured dedicated radio bearer; and

a temporary cell radio network temporary identifier CRNTI list.

According to one embodiment a network side device comprises:

a receiving module, configured to receive radio resource connection management signaling sent by a first terminal device, wherein the first terminal device implements a relay function, and the radio resource connection management signaling is sent by a second terminal device to the first terminal device;

a processing module, configured to determine an identifier of the second terminal device that generates the radio resource connection management signaling received by the receiving module, and obtain a security parameter corresponding to the identifier of the second terminal device; and

a sending module configured to send the obtained security parameter to the second terminal device by using the first terminal device.

For one embodiment, the radio resource connection management signaling carries the identifier of the second terminal device.

For one embodiment, the processing module is specifically configured to:

determine an identifier of a dedicated radio bearer for transmitting the radio resource connection management signaling, and determine, based on a correspondence between an identifier of a dedicated radio bearer and an identifier of a second terminal device, that an identifier of a second terminal device corresponding to the identifier of the dedicated radio bearer for transmitting the radio resource connection management signaling is the identifier of the second terminal device that generates the radio resource connection management signaling, wherein the dedicated radio bearer is a radio bearer between the network side device and the first terminal device; or

obtain signaling source indication information carried in the radio resource connection management signaling, determine, based on the signaling source indication information, that the radio resource connection management signaling is generated by the second terminal device, and determine the identifier of the second terminal device based on the radio resource connection management signaling, wherein the signaling source indication information is used to indicate that the radio resource connection management signaling is generated by the second terminal device.

For one embodiment, the sending module is further configured to:

send radio bearer configuration signaling to the first terminal device before the receiving module receives the radio resource connection management signaling sent by the first terminal device, where the radio bearer configuration signaling includes at least the identifier of the dedicated radio bearer that is to be configured for transmitting the radio resource connection management signaling of the second terminal device; and

the receiving module is further configured to:

receive radio bearer configuration complete signaling returned by the first terminal device, where the radio bearer configuration complete signaling is used to indicate that configuration of the dedicated radio bearer for transmitting the radio resource connection management signaling of the second terminal device is completed.

For one embodiment, the processing module is specifically configured to:

generate a secure transmission mode request, where the secure transmission mode request carries the security parameter; and

the sending module is specifically configured to:

send the secure transmission mode request generated by the processing module to the first terminal device, so that the first terminal device forwards the secure transmission mode request to the second terminal device.

For one embodiment, an attribute of a dedicated radio bearer carrying the secure transmission mode request includes the identifier of the second terminal device, the dedicated radio bearer is a radio bearer between the network side device and the first terminal device, and the first terminal device forwards the secure transmission mode request to the second terminal device based on the identifier of the second terminal device included in the attribute of the dedicated radio bearer; or

the secure transmission mode request further carries the identifier of the second terminal device, and the first terminal device forwards the secure transmission mode request to the second terminal device based on the identifier of the second terminal device carried in the secure transmission mode request.

For one embodiment, when the security parameter is used to transmit data between the second terminal device and the network side device, encryption and/or decryption and/or integrity protection and/or integrity protection check are/is performed on the data.

According to one embodiment a terminal device is disclosed that is a first terminal device with a relay function and comprises:

a first processing module, configured to after it is determined that a destination of radio resource connection management signaling of a second terminal device is a network side device, instruct a sending module to send the radio resource connection management signaling to the network side device; and

a second processing module, configured to receive, by using a receiving module, a security parameter returned by the network side device based on the radio resource connection management signaling, and instruct the sending module to forward the security parameter to the second terminal device, wherein the security parameter is obtained by the network side device based on an identifier of the second terminal device after the network side device determines the identifier of the second terminal device that generates the radio resource connection management signaling.

For one embodiment, the radio resource connection management signaling carries the identifier of the second terminal device.

For one embodiment, the first processing module is specifically configured to:

if determining that the receiving module receives, by using a dedicated air interface resource, the radio resource connection management signaling sent by the second terminal device, determine that the destination of the radio resource connection management signaling is the network side device, wherein the dedicated air interface resource is used to instruct the first terminal device to forward signaling of the second terminal device to the network side device; or

determine that the radio resource connection management signaling carries forwarding instruction information, and determine, based on the forwarding instruction information, that the destination of the radio resource connection management signaling is the network side device, wherein the forwarding instruction information is used to instruct to forward signaling of the second terminal device to the network side device.

For one embodiment, the first processing module is specifically configured to:

determine, based on a correspondence between an identifier of a second terminal device and an identifier of a dedicated radio bearer, an identifier of a dedicated radio bearer corresponding to the identifier of the second terminal device that generates the radio resource connection management signaling, and instruct the sending module to send the radio resource connection management signaling to the network side device based on the identifier of the dedicated radio bearer, wherein the dedicated radio bearer is a radio bearer between the network side device and the first terminal device; or

after signaling source indication information is added to the radio resource connection management signaling, instruct the sending module to send the radio resource connection management signaling to the network side device, wherein the signaling source indication information is used to indicate that the radio resource connection management signaling is generated by the second terminal device.

For one embodiment, the first processing module is further configured to:

before determining, based on the correspondence between an identifier of a second terminal device and an identifier of a dedicated radio bearer, the identifier of the dedicated radio bearer corresponding to the identifier of the second terminal device that generates the radio resource connection management signaling, receive, by using the receiving module, radio bearer configuration signaling sent by the network side device, wherein the radio bearer configuration signaling includes at least the identifier of the dedicated radio bearer that is to be configured for transmitting the radio resource connection management signaling of the second terminal device; and

after the dedicated radio bearer for forwarding the radio resource connection management signaling of the second terminal device is configured based on the radio bearer configuration signaling, instruct the sending module to return radio bearer configuration complete signaling to the network side device, wherein the radio bearer configuration complete signaling is used to indicate that configuration of the dedicated radio bearer for transmitting the radio resource connection management signaling of the second terminal device is completed.

For one embodiment, the second processing module is specifically configured to:

receive, by using the receiving module, a secure transmission mode request returned by the network side device, wherein the secure transmission mode request carries the security parameter; and instruct the sending module to forward the secure transmission mode

request to the second terminal device.

For one embodiment, the second processing module is specifically configured to:

determine the identifier of the second terminal device included in an attribute of a dedicated radio bearer carrying the secure transmission mode request, wherein the dedicated radio bearer is a radio bearer between the network side device and the first terminal device; and forward, by using the sending module, the secure transmission mode request to the second terminal device based on the identifier of the second terminal device included in the attribute of the dedicated radio bearer; or

if the secure transmission mode request further carries the identifier of the second terminal device, forward, by using the sending module, the secure transmission mode request to the second terminal device based on the identifier of the second terminal device carried in the secure transmission mode request.

For one embodiment, the first terminal device and the second terminal device establish a wireless connection with each other by using a device-to-device D2D protocol, a Bluetooth protocol, or a Wireless Fidelity Wi-Fi protocol.

According to one embodiment a terminal device comprises:

a sending module configured to send radio resource connection management signaling to a first terminal device, wherein the first terminal device forwards the radio resource connection management signaling to a network side device after determining that a destination of the radio resource connection management signaling is the network side device, where the first terminal device has a relay function; and

a receiving module configured to receive a security parameter returned by the network side device by using the first terminal device, wherein the security parameter is obtained by the network side device based on an identifier of the terminal device after the network side device determines the identifier of the terminal device that generates the radio resource connection management signaling.

For one embodiment, the radio resource connection management signaling includes the identifier of the terminal device.

For one embodiment, the sending module is specifically configured to:

send the radio resource connection management signaling to the first terminal device by using a dedicated air interface resource, wherein the dedicated air interface resource is used to instruct to forward signaling of the terminal device to the network side device; or

send the radio resource connection management signaling to the first terminal device after forwarding instruction information is added to the radio resource connection management signaling, where the forwarding instruction information is used to instruct to forward signaling of the terminal device to the network side device.

For one embodiment, the first terminal device and the terminal device establish a wireless connection with each other by using a device-to-device D2D protocol, a Bluetooth protocol, or a Wireless Fidelity Wi-Fi protocol.

According to one embodiment a network side device comprises:

a sending module configured to send radio bearer configuration signaling to a first terminal device, where the radio bearer configuration signaling includes at least an identifier of a dedicated radio bearer that is to be configured for transmitting radio resource connection management signaling of a second terminal device, the dedicated radio bearer is a radio bearer between the network side device and the first terminal device, and the first terminal device has a relay function; and

a receiving module configured to receive radio bearer configuration complete signaling returned by the first terminal device, where the radio bearer configuration complete signaling is used to indicate that configuration of the dedicated radio bearer for transmitting the radio resource connection management signaling of the second terminal device is completed.

For one embodiment, the radio bearer configuration signaling further includes any one or a combination of the following:

relay indication information used to indicate that the to-be-configured dedicated radio bearer is used to relay data of the second terminal device;

a second terminal device identifier or a second terminal device identifier list, used to indicate that the to-be-configured dedicated radio bearer is used to transmit data of a second terminal device indicated by the second terminal device identifier or the second terminal device identifier list;

a configuration parameter of a radio link control layer;

Medium Access Control MAC configuration information, used to indicate a logical channel group of the to-be-configured dedicated radio bearer; and

a temporary cell radio network temporary identifier CRNTI list.

According to one embodiment a terminal device is disclosed and the terminal device is a first terminal device with a relay function and comprises:

a receiving module configured to receive radio bearer configuration signaling sent by a network side device, where the radio bearer configuration signaling includes at least an identifier of a dedicated radio bearer that is to be configured for transmitting radio resource connection management signaling of a second terminal device, and the dedicated radio bearer is a radio bearer between the network side device and the first terminal device; and

a sending module configured to return radio bearer configuration complete signaling to the network side device after the dedicated radio bearer for forwarding the radio resource connection management signaling of the second terminal device is configured based on the radio bearer configuration signaling, wherein the radio bearer configuration complete signaling is used to indicate that configuration of the dedicated radio bearer for transmitting the radio resource connection management signaling of the second terminal device is completed.

For one embodiment, the radio bearer configuration signaling further includes any one or a combination of the following:

relay indication information used to indicate that the to-be-configured dedicated radio bearer is used to relay data of the second terminal device;

a second terminal device identifier or a second terminal device identifier list, used to indicate that the to-be-configured dedicated radio bearer is used to transmit data of a second terminal device indicated by the second terminal device identifier or the second terminal device identifier list;

a configuration parameter of a radio link control layer;

Medium Access Control MAC configuration information, used to indicate a logical channel group of the to-be-configured dedicated radio bearer; and

a temporary cell radio network temporary identifier CRNTI list.

According to one embodiment a network side device comprises a processor, a memory, and a transceiver. The transceiver is configured to receive and send data under the control of the processor, the memory stores a preset program, and the processor is configured to: read the program stored in the memory, and perform the following processes based on the program:

receiving, by using the transceiver, radio resource connection management signaling sent by a first terminal device, where the first terminal device implements a relay function, and the radio resource connection management signaling is sent by a second terminal device to the first terminal device;

determining an identifier of the second terminal device that generates the radio resource connection management signaling, and obtaining a security parameter corresponding to the identifier of the second terminal device; and

instructing the transceiver to send the obtained security parameter to the second terminal device by using the first terminal device.

For one embodiment, the radio resource connection management signaling includes the identifier of the second terminal device.

For one embodiment, the processor determines an identifier of a dedicated radio bearer for transmitting the radio resource connection management signaling, and determines, based on a correspondence between an identifier of a dedicated radio bearer and an identifier of a second terminal device, that an identifier of a second terminal device corresponding to the identifier of the dedicated radio bearer for transmitting the radio resource connection management signaling is the identifier of the second terminal device that generates the radio resource connection management signaling, wherein the dedicated radio bearer is a radio bearer between the network side device and the first terminal device; or

the processor obtains signaling source indication information carried in the radio resource connection management signaling, determines, based on the signaling source indication information, that the radio resource connection management signaling is generated by the second terminal device, and determines the identifier of the second terminal device based on the radio resource connection management signaling, where the signaling source indication information is used to indicate that the radio resource connection management signaling is generated by the second terminal device.

For one embodiment, the processor sends radio bearer configuration signaling to the first terminal device before receiving, by using the transceiver, the radio resource connection management signaling sent by the first terminal device, wherein the radio bearer configuration signaling includes at least the identifier of the dedicated radio bearer that is to be configured for transmitting the radio resource connection management signaling of the second terminal device; and

the processor receives, by using the transceiver, radio bearer configuration complete signaling returned by the first terminal device, where the radio bearer configuration complete signaling is used to indicate that configuration of the dedicated radio bearer for transmitting the radio resource connection management signaling of the second terminal device is completed.

For one embodiment, the processor generates a secure transmission mode request, where the secure transmission mode request carries the security parameter; and instructs the transceiver to send the generated secure transmission mode request to the first terminal device, so that the first terminal device forwards the secure transmission mode request to the second terminal device.

For one embodiment, an attribute of a dedicated radio bearer carrying the secure transmission mode request includes the identifier of the second terminal device, the dedicated radio bearer is a radio bearer between the network side device and the first terminal device, and the first terminal device forwards the secure transmission mode request to the second terminal device based on the identifier of the second terminal device included in the attribute of the dedicated radio bearer; or

the secure transmission mode request further carries the identifier of the second terminal device, and the first terminal device forwards the secure transmission mode request to the second terminal device based on the identifier of the second terminal device carried in the secure transmission mode request.

For one embodiment, when the security parameter is used to transmit data between the second terminal device and the network side device, encryption and/or decryption and/or integrity protection and/or integrity protection check are/is performed on the data.

According to one embodiment a terminal device is disclosed that is a first terminal device with a relay function and comprises a processor, a memory, and a transceiver. The transceiver is configured to receive and send data under the control of the processor, the memory stores a preset program, and the processor is configured to: read the program stored in the memory, and perform the following processes based on the program:

after it is determined that a destination of radio resource connection management signaling of a second terminal device is a network side device, instructing the transceiver to send the radio resource connection management signaling to the network side device; and

receiving, by using the transceiver, a security parameter returned by the network side device based on the radio resource connection management signaling, and instructing the transceiver to forward the security parameter to the second terminal device, where the security parameter is obtained by the network side device based on an identifier of the second terminal device after the network side device determines the identifier of the second terminal device that generates the radio resource connection management signaling.

For one embodiment, the radio resource connection management signaling carries the identifier of the second terminal device.

For one embodiment, if determining that the transceiver receives, by using a dedicated air interface resource, the radio resource connection management signaling sent by the second terminal device, the processor determines that the destination of the radio resource connection management signaling is the network side device, wherein the dedicated air interface resource is used to instruct the first terminal device to forward signaling of the second terminal device to the network side device; or

the processor determines that the radio resource connection management signaling carries forwarding instruction information, and determines, based on the forwarding instruction information, that the destination of the radio resource connection management signaling is the network side device, wherein the forwarding instruction information is used to instruct to forward signaling of the second terminal device to the network side device.

For one embodiment, the processor determines, based on a correspondence between an identifier of a second terminal device and an identifier of a dedicated radio bearer, an identifier of a dedicated radio bearer corresponding to the identifier of the second terminal device that generates the radio resource connection management signaling, and instructs the transceiver to send the radio resource connection management signaling to the network side device based on the identifier of the dedicated radio bearer, where the dedicated radio bearer is a radio bearer between the network side device and the first terminal device; or

after signaling source indication information is added to the radio resource connection management signaling, the processor instructs the transceiver to send the radio resource connection management signaling to the network side device, wherein the signaling source indication information is used to indicate that the radio resource connection management signaling is generated by the second terminal device.

For one embodiment, before determining, based on the correspondence between an identifier of a second terminal device and an identifier of a dedicated radio bearer, the identifier of the dedicated radio bearer corresponding to the identifier of the second terminal device that generates the radio resource connection management signaling, the processor receives, by using the transceiver, radio bearer configuration signaling sent by the network side device, where the radio bearer configuration signaling includes at least the identifier of the dedicated radio bearer that is to be configured for transmitting the radio resource connection management signaling of the second terminal device; and

after the dedicated radio bearer for forwarding the radio resource connection management signaling of the second terminal device is configured based on the radio bearer configuration signaling, the processor instructs the transceiver to return radio bearer configuration complete signaling to the network side device, wherein the radio bearer configuration complete signaling is used to indicate that configuration of the dedicated radio bearer for transmitting the radio resource connection management signaling of the second terminal device is completed.

For one embodiment, the processor receives, by using the transceiver, a secure transmission mode request returned by the network side device, where the secure transmission mode request carries the security parameter; and the processor instructs the transceiver to forward the secure transmission mode request to the second terminal device.

For one embodiment, the processor determines the identifier of the second terminal device included in an attribute of a dedicated radio bearer carrying the secure transmission mode request, wherein the dedicated radio bearer is a radio bearer between the network side device and the first terminal device; and forwards, by using the transceiver, the secure transmission mode request to the second terminal device based on the identifier of the second terminal device included in the attribute of the dedicated radio bearer; or

if the secure transmission mode request further includes the identifier of the second terminal device, the processor forwards, by using the transceiver, the secure transmission mode request to the second terminal device based on the identifier of the second terminal device carried in the secure transmission mode request.

For one embodiment, the first terminal device and the second terminal device establish a wireless connection with each other by using a device-to-device D2D protocol, a Bluetooth protocol, or a Wireless Fidelity Wi-Fi protocol.

According to one embodiment another terminal device is disclosed comprising a processor, a memory, and a transceiver. The transceiver is configured to receive and send data under the control of the processor, the memory stores a preset program, and the processor is configured to: read the program stored in the memory, and perform the following processes based on the program:

instructing the transceiver to send radio resource connection management signaling to a first terminal device, so that the first terminal device forwards the radio resource connection management signaling to a network side device after determining that a destination of the radio resource connection management signaling is the network side device, wherein the first terminal device has a relay function; and

receiving, by using the transceiver, a security parameter returned by the network side device by using the first terminal device, where the security parameter is obtained by the network side device based on an identifier of the terminal device after the network side device determines the identifier of the terminal device that generates the radio resource connection management signaling.

For one embodiment, the radio resource connection management signaling carries the identifier of the terminal device.

For one embodiment, the processor instructs the transceiver to send the radio resource connection management signaling to the first terminal device by using a dedicated air interface resource, wherein the dedicated air interface resource is used to instruct to forward signaling of the terminal device to the network side device; or

after forwarding instruction information is added to the radio resource connection management signaling, the processor instructs the transceiver to send the radio resource connection management signaling to the first terminal device, wherein the forwarding instruction information is used to instruct to forward signaling of the terminal device to the network side device.

For one embodiment, the first terminal device and the terminal device establish a wireless connection with each other by using a device-to-device D2D protocol, a Bluetooth protocol, or a Wireless Fidelity Wi-Fi protocol.

According to one embodiment another network side device is disclosed comprising a processor, a memory, and a transceiver. The transceiver is configured to receive and send data under the control of the processor, the memory stores a preset program, and the processor is configured to: read the program stored in the memory, and perform the following processes based on the program:

instructing the transceiver to send radio bearer configuration signaling to a first terminal device, where the radio bearer configuration signaling includes at least an identifier of a dedicated radio bearer that is to be configured for transmitting radio resource connection management signaling of a second terminal device, the dedicated radio bearer is a radio bearer between the network side device and the first terminal device, and the first terminal device has a relay function; and

instructing the transceiver to receive radio bearer configuration complete signaling returned by the first terminal device, wherein the radio bearer configuration complete signaling is used to indicate that configuration of the dedicated radio bearer for transmitting the radio resource connection management signaling of the second terminal device is completed.

For one embodiment, the radio bearer configuration signaling further includes any one or a combination of the following:

relay indication information used to indicate that the to-be-configured dedicated radio bearer is used to relay data of the second terminal device;

a second terminal device identifier or a second terminal device identifier list, used to indicate that the to-be-configured dedicated radio bearer is used to transmit data of a second terminal device indicated by the second terminal device identifier or the second terminal device identifier list;

a configuration parameter of a radio link control layer;

Medium Access Control MAC configuration information, used to indicate a logical channel group of the to-be-configured dedicated radio bearer; and

a temporary cell radio network temporary identifier CRNTI list.

According to one embodiment another terminal device is disclosed that is is a first terminal device with a relay function and comprises a processor, a memory, and a transceiver. The transceiver is configured to receive and send data under the control of the processor, the memory stores a preset program, and the processor is configured to: read the program stored in the memory, and perform the following processes based on the program:

receiving, by using the transceiver, radio bearer configuration signaling sent by a network side device, where the radio bearer configuration signaling includes at least an identifier of a dedicated radio bearer that is to be configured for transmitting radio resource connection management signaling of a second terminal device, and the dedicated radio bearer is a radio bearer between the network side device and the first terminal device; and

after the dedicated radio bearer for forwarding the radio resource connection management signaling of the second terminal device is configured based on the radio bearer configuration signaling, returning, by using the transceiver, radio bearer configuration complete signaling to the network side device, wherein the radio bearer configuration complete signaling is used to indicate that configuration of the dedicated radio bearer for transmitting the radio resource connection management signaling of the second terminal device is completed.

For one embodiment, the radio bearer configuration signaling further includes any one or a combination of the following:

relay indication information used to indicate that the to-be-configured dedicated radio bearer is used to relay data of the second terminal device;

a second terminal device identifier or a second terminal device identifier list, used to indicate that the to-be-configured dedicated radio bearer is used to transmit data of a second terminal device indicated by the second terminal device identifier or the second terminal device identifier list;

a configuration parameter of a radio link control layer;

Medium Access Control MAC configuration information, used to indicate a logical channel group of the to-be-configured dedicated radio bearer; and

a temporary cell radio network temporary identifier CRNTI list.

### BRIEF DESCRIPTION OF DRAWINGS

FIG. 1 is a schematic diagram of a scenario of intra-cell coverage in D2D deployment;

FIG. 2 is a schematic diagram of a scenario of partial coverage in D2D deployment;

FIG. 3 is a schematic diagram of a scenario of no network coverage in D2D deployment;

FIG. 4 is a schematic diagram of a scenario of inter-cell coverage in D2D deployment;

FIG. 5 is a schematic diagram of establishing a connection to a network by UE outside coverage of the network;

FIG. 6 is a schematic architectural diagram of a control plane protocol stack according to one embodiment;

FIG. 7 is a schematic architectural diagram of a user plane protocol stack according to one embodiment;

FIG. 8 is a schematic flowchart of a security parameter transmission method according to one embodiment;

FIG. 9 is a schematic structural diagram of a part of a MAC PDU of a D2D message according to one embodiment;

FIG. 10 is a schematic diagram of a security parameter transmission process according to one embodiment;

FIG. 11 is a schematic diagram of a process of setting up a dedicated radio bearer between a network side device and a first terminal device according to one embodiment;

FIG. 12 is a schematic structural diagram of a network side device according to one embodiment;

FIG. 13 is a schematic structural diagram of another network side device according to one embodiment;

FIG. 14 is a schematic structural diagram of a terminal device according to one embodiment;

FIG. 15 is a schematic structural diagram of another terminal device according to one embodiment;

FIG. 16 is a schematic structural diagram of another terminal device according to one embodiment;

FIG. 17 is a schematic structural diagram of another terminal device according to one embodiment;

FIG. 18 is a schematic structural diagram of another network side device according to one embodiment;

FIG. 19 is a schematic structural diagram of another network side device according to one embodiment;

FIG. 20 is a schematic structural diagram of another terminal device according to one embodiment; and

FIG. 21 is a schematic structural diagram of another terminal device according to one embodiment.

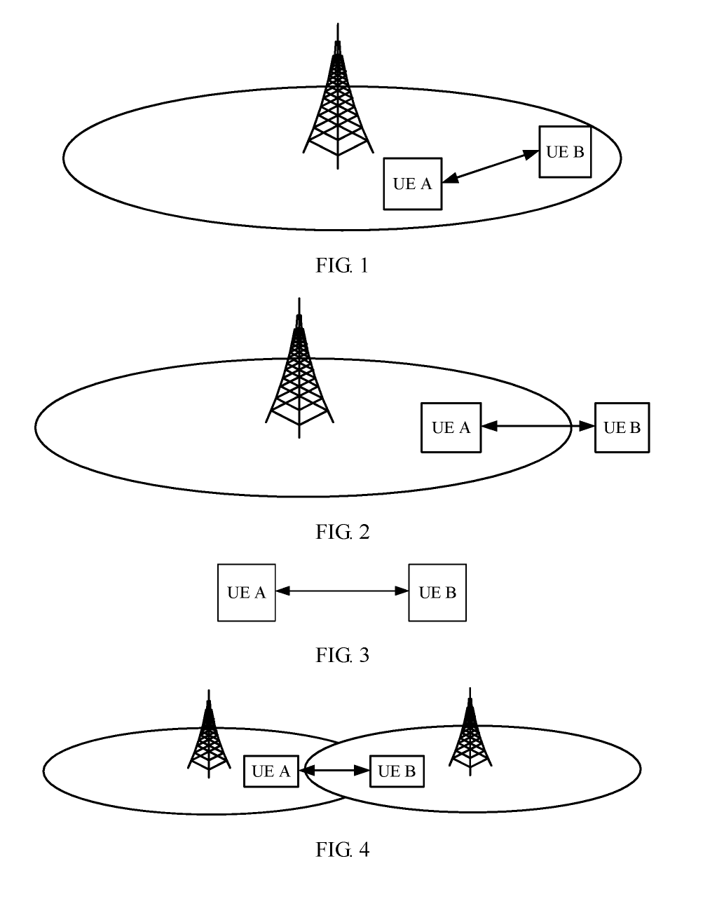

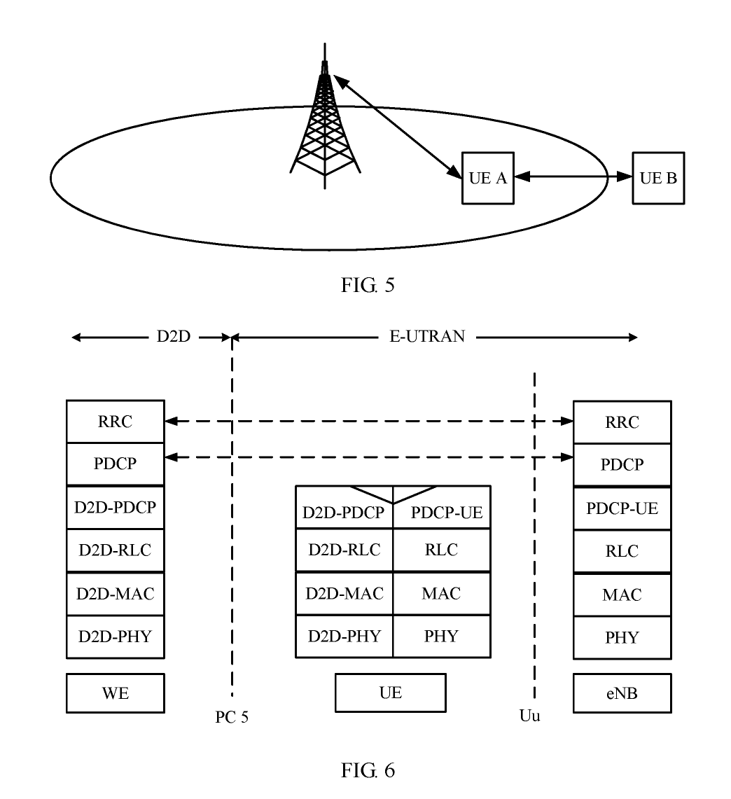

### DESCRIPTION OF EMBODIMENTS

In the following embodiments, a Long Term Evolution (LTE) system is used as an example for description purposes. The disclosed embodiments, however, are not intended to be limited to the LTE system, and may also be applied to other communication systems.

In the following embodiments, a second terminal device refers to a device that needs to use a first terminal device as a relay to communicate with a network side device, that is, a remote device. For example, the second terminal device can be wearable equipment. The first terminal device can implement a relay function, and may also be referred to as a relay terminal. The second terminal device includes, but is not limited, to the wearable equipment. Specifically, the wearable equipment can be a communication device worn on a human body, and can be characterized by a small size and a low battery capacity. The wearable equipment may be directly connected to a cellular network, or may be connected to the cellular network by using nearly UE as a relay.

To implement secured communication between the second terminal device in a direct cellular connection mode and the cellular network, an architecture is disclosed in which the second terminal device accesses the network and, the first terminal device forwards a message of the second terminal device to the network side device. The first terminal device can forward a message of the network side device to the second terminal device. In the forwarding process, the first terminal device can be confined to only forwarding a message between the second terminal device and the network side device, and may not decrypt a message forwarded between the second terminal device and the network side device.

Based on such an architecture, a simplified radio resource control (RRC) connection can be established between the second terminal device and the network side device, and the network side device can transmit a security parameter of the second terminal device to the second terminal device to implement management on the second terminal device by the network side device, and implement security protection of the transmitted message by the network side device and the second terminal device.

For one embodiment, when the security parameter is used to transmit data between the second terminal device and the network side device, encryption and/or decryption and/or integrity protection and/or integrity protection check can be performed on the data.

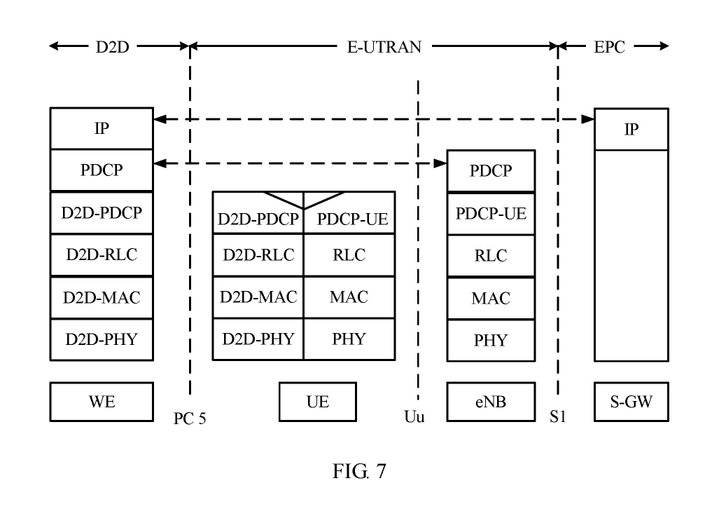

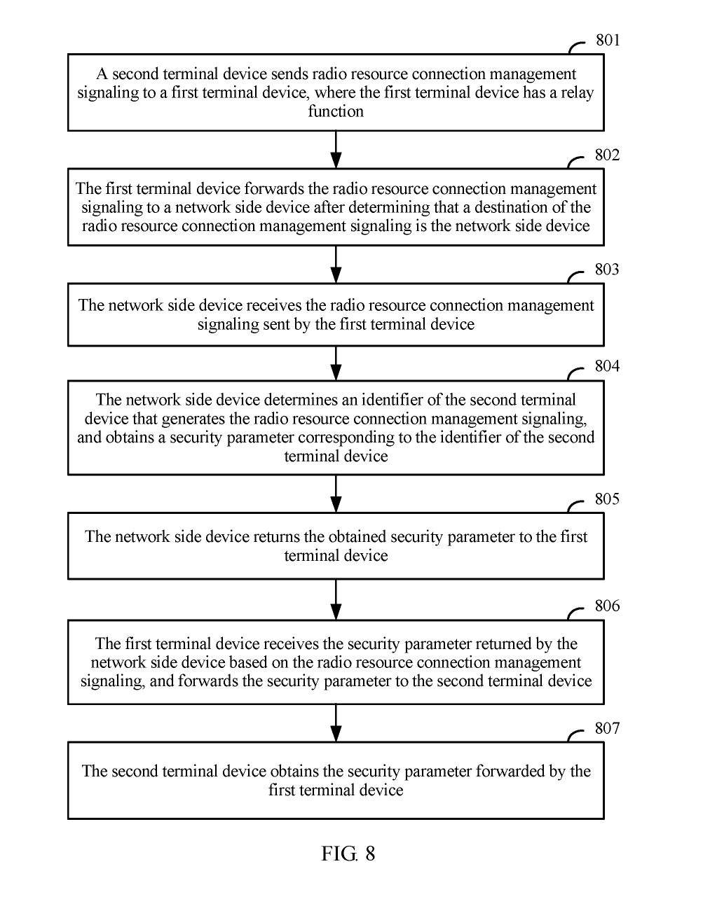

FIG. 6 is a schematic diagram of a control plane protocol stack between a second terminal device, a first terminal device, and a base station (eNB). FIG 7 is a schematic diagram of a user plane protocol stack between a second terminal device, a first terminal device, and a base station (eNB). Architectures of a control plane protocol stack and a user plane protocol stack used between the second terminal device and the eNB can enable the eNB to directly manage the second terminal device, such that the eNB can configure parameters of a control pane and a data plane of an RRC connection for the second terminal device. This can, for example, configure security parameters of data and signaling transmitted from the second terminal device to the eNB.

For one embodiment, on a control plane, there can be a peer-to-peer RRC layer and a Packet Data Convergence Protocol (PDCP) layer between the second terminal device and the eNB. The RRC layer is responsible for managing parameter configuration of an access link of the second terminal device and establishing a bearer of the second terminal device. The bearer of the second terminal device includes a radio bearer for accessing the eNB by the second terminal device and a bearer from the eNB to a core network.

For one embodiment, on a user plane, for uplink data, the second terminal device processes an Internet Protocol (IP) data packet of an upper layer on a PDCP layer, and then the first terminal device forwards the processed data packet to the eNB. For downlink data, the eNB sends a data packet of the core network to the PDCP layer for processing, and then the first terminal device forwards the processed data packet to the second terminal device.

For one embodiment, the control plane protocol stack and the user plane protocol stack are used. For a core network device such as a mobility management entity (MME), a serving gateway (SGW), or a packet data gateway (PGW), the second terminal device is directly connected to the eNB by using a UU interface, such that compatibility of the core network can be maintained. In addition, when the second terminal device is relatively far away from the first terminal device, if the second terminal device is directly connected to the eNB by using the UU interface, the eNB can still store a context of the second terminal device, so that a transmission capability of service data can be rapidly restored, a mobility processing procedure is simplified, and a delay is reduced. For the eNB, an RRC context of the second terminal device, especially a security parameter, is directly managed by the eNB, and only the second terminal device and a PDCP layer of the eNB participate in integrity protection, encryption, and decryption of signaling and data transmission, and, therefore, relay UE cannot decrypt signaling and data of the second terminal device. This ensures security of communicating by the second terminal device with the eNB by using any first terminal device.

The following embodiments provide a solution to a transmission problem of a security parameter required for secure communication between a second terminal device and a cellular network.

For one embodiment, a security parameter transmission process is shown in FIG. 8. Referring to FIG. 8, the process includes Steps 801 through 806.

At Step 801, a second terminal device sends radio resource connection management signaling to a first terminal device, where the first terminal device has a relay function.

The radio resource connection management signaling is used to request to obtain a security parameter.

The radio resource connection management information belongs to RRC signaling.

For one embodiment, the radio resource connection management signaling carries an identifier of the second terminal device.

The second terminal device sends the radio resource connection management signaling to the first terminal device, and the first terminal device needs to determine that the radio resource connection management information is to be forwarded to a network side device.

For one embodiment, the second terminal device sends the radio resource connection management signaling to the first terminal device by using a dedicated air interface resource. The dedicated air interface resource is used to forward signaling of the second terminal device to the network side device.

The dedicated air interface resource may be a dedicated physical resource or a dedicated logical channel entity.

D2D communication is used as an example. An added feature of LTE-D2D may enable a data packet to be sent between the second terminal device and the first terminal device by using the dedicated air interface resource. Specifically, a dedicated bearer D2D—data radio bearer (Data Radio Bearer, DRB) is established between the second terminal device and the first terminal device, and the D2D-DRB is assigned to be specially used by the first terminal device to forward signaling or data of the second terminal device to the network side device. That is, the first terminal device forwards, to a base station, the signaling or the data of the second terminal device received by using the D2D-DRB. When a sending destination of signaling of the network device is the first terminal device, the second terminal device sends the signaling by using the D2D-DRB.

For one embodiment, the first terminal device does not need to parse a received data packet, and only needs to determine whether to receive the data packet by using the dedicated air interface resource in order to determine whether the data packet needs to be forwarded to the network side device.

For one embodiment, the second terminal device sends the radio resource connection management signaling to the first terminal device by adding forwarding instruction information to the radio resource connection management signaling. The forwarding instruction information is used to instruct the first terminal device to forward signaling of the second terminal device to the network side device.

D2D communication is used as an example. When the second terminal device and the first terminal device communicate with each other by using an LTE-D2D technology in the 3GPP standard because a data packet is sent in a broadcast mode in LTE-D2D after receiving a data packet sent by the second terminal device through broadcasting, the first terminal device cannot determine whether the data packet needs to be forwarded to RRC signaling of the base station. Therefore, the second terminal device adds forwarding instruction information to a MAC PDU of a D2D message sent through broadcasting, to instruct the first terminal device receiving the D2D message to forward connection management information carried in the MAC PDU of the D2D message to the base station.

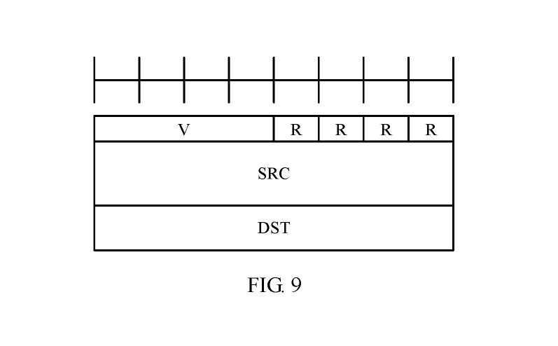

FIG. 9 is a schematic structural diagram of a part of a MAC PDU of a D2D message. For one embodiment, two R bits in oct1 may be used to indicate whether a data packet needs to be forwarded. It is assumed that in the two R bits, “00” indicates receiving and self-processing, “01” indicates receiving and forwarding to another D2D UE, and “10” indicates receiving and forwarding to a base station. If there are more processing types, more bits may be occupied to carry forwarding instruction information. For example, three or four R bits are occupied. A third R bit in the oct1 may be used to identify whether a data packet carried in a MAC PDU is signaling or common service data. A logical channel identifier (LCD) carried in the MAC PDU is an identifier of a logical channel group corresponding to a radio bearer that is on a UU interface of the first terminal device and that is used to forward a message of the second terminal device.

At Step 802, the first terminal device forwards the radio resource connection management signaling to a network side device after determining that a destination of the radio resource connection management signaling is the network side device.

For one embodiment, corresponding to the examples disclosed in Step 801, how the first terminal device determines that the destination of the radio resource connection management signaling of the second terminal device is the network side device includes, but is not limited. to the following exemplary embodiments.

For one embodiment, the destination of the radio resource connection management signaling is determined based on a dedicated air interface resource that is occupied to transmit the connection management information between the second terminal device and the first terminal device.

For example, if determining to receive, by using the dedicated air interface resource, the radio resource connection management signaling sent by the second terminal device, the first terminal device determines that the destination of the radio resource connection management signaling is the network side device. The dedicated air interface resource is used to instruct the first terminal device to forward signaling of the second terminal device to the network side device.

For one embodiment, the destination of the radio resource connection management signaling is determined based on forwarding instruction information carried in the radio resource connection management signaling.

For example, the first terminal device determines that the radio resource connection management signaling carries the forwarding instruction information, and determines, based on the forwarding instruction information, that the destination of the radio resource connection management signaling is the network side device. The forwarding instruction information is used to instruct to forward signaling of the second terminal device to the network side device.

For one embodiment, the first terminal device sends the radio resource connection management signaling to the network side device, and this includes, but is not limited, to the following embodiments.

For one embodiment, the first terminal device determines, based on a correspondence between an identifier of a second terminal device and an identifier of a dedicated radio bearer. The identifier of the dedicated radio bearer corresponds to the identifier of the second terminal device that generates the radio resource connection management signaling. The first terminal device sends the radio resource connection management signaling to the network side device based on the identifier of the dedicated radio bearer. The dedicated radio bearer is a radio bearer between the network side device and the first terminal device.

For example, a dedicated radio bearer between the first terminal device and the network side device may be used to transmit signaling of one specific second terminal device, or may be used to transmit signaling of a plurality of second terminal devices.

For one embodiment, if the dedicated radio bearer between the first terminal device and the network side device is specially used to carry signaling of one second terminal device, based on the correspondence between an identifier of a second terminal device and an identifier of a dedicated radio bearer, the first terminal device may uniquely determine a dedicated radio bearer based on an identifier of a second terminal device. The dedicated radio bearer can be used for the second terminal device, and the network side device may uniquely determine a second terminal device based on an identifier of a dedicated radio bearer.

For one embodiment, if the dedicated radio bearer between the first terminal device and the network side device is used to carry signaling of a plurality of second terminal devices, the first terminal device may uniquely determine a dedicated radio bearer based on an identifier of a second terminal device. However, because the dedicated radio bearer may be used to transmit the signaling of the plurality of second terminal devices, the network side device may not uniquely determine a second terminal device based on an identifier of a dedicated radio bearer, and further needs to perform a second implementation.

For one embodiment, the network side device is a base station. The base station can configure a dedicated signaling radio bearer (SRB) between the first terminal device and the base station for the first terminal device, for example, an SRB 5 that is specially used by the first terminal device to transmit RRC signaling of the second terminal device.

A process of configuring the dedicated radio bearer between the network side device and the first terminal device is described as follows:

For one embodiment, the network side device sends radio bearer configuration signaling to the first terminal device. The radio bearer configuration signaling includes at least the identifier of the dedicated radio bearer that is to be configured for transmitting the radio resource connection management signaling of the second terminal device. The first terminal device receives the radio bearer configuration signaling sent by the network side device, and returns radio bearer configuration complete signaling to the network side device after configuring, based on the radio bearer configuration signaling, the dedicated radio bearer for forwarding the radio resource connection management signaling of the second terminal device. The radio bearer configuration complete signaling is used to indicate that configuration of the dedicated radio bearer for transmitting the radio resource connection management signaling of the second terminal device is completed. The network side device receives the radio bearer configuration complete signaling returned by the first terminal device.

For example, the dedicated radio bearer is an SRB. Further, the radio bearer configuration signaling further includes one or a combination of the following information:

Relay indication information (relay indicator) that indicates that the to-be-configured dedicated radio bearer is used to relay data of the second terminal device.

A second terminal device identifier (remote UE ID) or a second terminal device identifier list (remote UE ID list) that indicates the dedicated radio bearer may be used to transmit data of a second terminal device indicated by the second terminal device identifier or the second terminal device identifier list.

A configuration parameter of a radio link control (RLC) layer such that the parameter needs to keep the same as an RLC parameter of a common terminal.

MAC configuration information (MAC-config) that indicates a logical channel group (Logical channel group) of the dedicated radio bearer, for example, a logical channel identifier 5.

A temporary cell radio network temporary identifier (CRNTI) list such that the second terminal device does not establish an RRC link to a network, and the second terminal device is linked with relay UE without obtaining an identifier allocated by the network, the relay UE allocates, based on the temporary CRNTI list, a temporary identifier to the second terminal device linked with the relay UE.

For one embodiment, the first terminal device sends the radio resource connection management signaling to the network side device after adding signaling source indication information to the radio resource connection management signaling. The signaling source indication information is used to indicate that the radio resource connection management signaling is generated by the second terminal device.

For example, when no dedicated radio bearer is configured between the first terminal device and the network side device, the network side device specifies the first terminal device to use an existing radio bearer to forward signaling of the second terminal device. For another example, the network side device configures only one dedicated radio bearer for the first terminal device, and the dedicated radio bearer is used by the first terminal device to forward signaling of the second terminal device to the network side device. In this case, the network side device cannot identify a source of signaling based only on a radio bearer carrying the signaling, and needs to add source indication information to the signaling. For example, if the network side device identifies that the source indication information in the signaling indicates the second terminal device, the network side device determines that the signaling is generated by the second terminal device; or if the network device identifies that the source indication information in the signaling indicates the first terminal device, the network device determines that the signaling is generated by the first terminal device.

For example, when the signaling source indication information indicates that the source is the second terminal device, the signaling source indication information may be the identifier of the second terminal device. The identifier of the second terminal device may be configured by the network side device, or may be notified after being negotiated and determined by the first terminal device and the network side device, or may be predefined.

At Step 803, the network side device receives the radio resource connection management signaling sent by the first terminal device.

For one embodiment, after the network side device receives the radio resource connection management information of the second terminal device forwarded by the first terminal device, if the network side device finds that the second terminal device accesses the network side for the first time, the network side device needs to verify an identity of the second terminal device based on subscription information of the second terminal device. The network side device then performs subsequent processing after verifying that the second terminal device is valid.

At Step 804, the network side device determines an identifier of the second terminal device that generates the radio resource connection management signaling, and obtains a security parameter corresponding to the identifier of the second terminal device.

For one embodiment, the network side device determines the identifier of the second terminal device that generates the radio resource connection management signaling, and this includes but is not limited to the following two implementations:

For one embodiment, the network side device determines an identifier of a dedicated radio bearer for transmitting the radio resource connection management signaling. The network side device also determines, based on a correspondence between an identifier of a dedicated radio bearer and an identifier of a second terminal device, that an identifier of a second terminal device corresponding to the identifier of the dedicated radio bearer for transmitting the radio resource connection management signaling is the identifier of the second terminal device that generates the radio resource connection management signaling.

For one embodiment, the dedicated radio bearer is a radio bearer between the network side device and the first terminal device.

For one embodiment, the network side device obtains signaling source indication information carried in the radio resource connection management signaling. The network side device determines, based on the signaling source indication information, that the radio resource connection management signaling is generated by the second terminal device. The network side device also determines the identifier of the second terminal device based on the radio resource connection management signaling. The signaling source indication information is used to indicate that the radio resource connection management signaling is generated by the second terminal device.

For one embodiment, the signaling source indication information is the identifier of the second terminal device. For example, the signaling source indication information is a CRNTI, a temporary mobile subscriber identity (TMSI), or an Internet Protocol (IP) address of the second terminal device.

At Step 805, the network side device returns the obtained security parameter to the first terminal device.

For example, the network side device generates a secure transmission mode request carrying the security parameter, and sends the secure transmission mode request to the first terminal device.

At Step 806, the first terminal device receives the security parameter returned by the network side device based on the radio resource connection management signaling, and forwards the security parameter to the second terminal device.

For example, the first terminal device receives the secure transmission mode request that carries the security parameter and that is sent by the network side, and forwards the secure transmission mode request to the second terminal device.

For one embodiment, the first terminal device forwards the secure transmission mode request to the second terminal device, and this includes but is not limited to the following two specific implementations:

For one embodiment, a dedicated radio bearer used for transmitting the secure transmission mode request between the first terminal device and the network side device is determined, and determining is performed based on attribute information of the dedicated radio bearer.

For example, the first terminal device determines the identifier of the second terminal device included in an attribute of a dedicated radio bearer carrying the secure transmission mode request, and forwards the secure transmission mode request to the second terminal device based on the identifier of the second terminal device included in the attribute of the dedicated radio bearer.

For one embodiment, the secure transmission mode request further includes the identifier of the second terminal device, and the secure transmission mode request is forwarded based on the identifier of the second terminal device carried in the secure transmission mode request.

For example, the first terminal device forwards the secure transmission mode request to the second terminal device based on the identifier of the second terminal device carried in the secure transmission mode request.

At Step 807, the second terminal device obtains the security parameter forwarded by the first terminal device.

For one embodiment, the network side device transmits the secure transmission mode request to the first terminal device, and this includes but is not limited to the following two specific implementations:

For one embodiment, the network side device sends the secure transmission mode request to the first terminal device by using a dedicated radio bearer. The dedicated radio bearer is a radio bearer between the network side device and the first terminal device.

For example, the attribute of the dedicated radio bearer carrying the secure transmission mode request includes the identifier of the second terminal device. The first terminal device forwards the secure transmission mode request to the second terminal device based on the identifier of the second terminal device included in the attribute of the dedicated radio bearer.

For one embodiment, the secure transmission mode request further includes the identifier of the second terminal device.

The first terminal device forwards the secure transmission mode request to the second terminal device based on the identifier of the second terminal device carried in the secure transmission mode request.

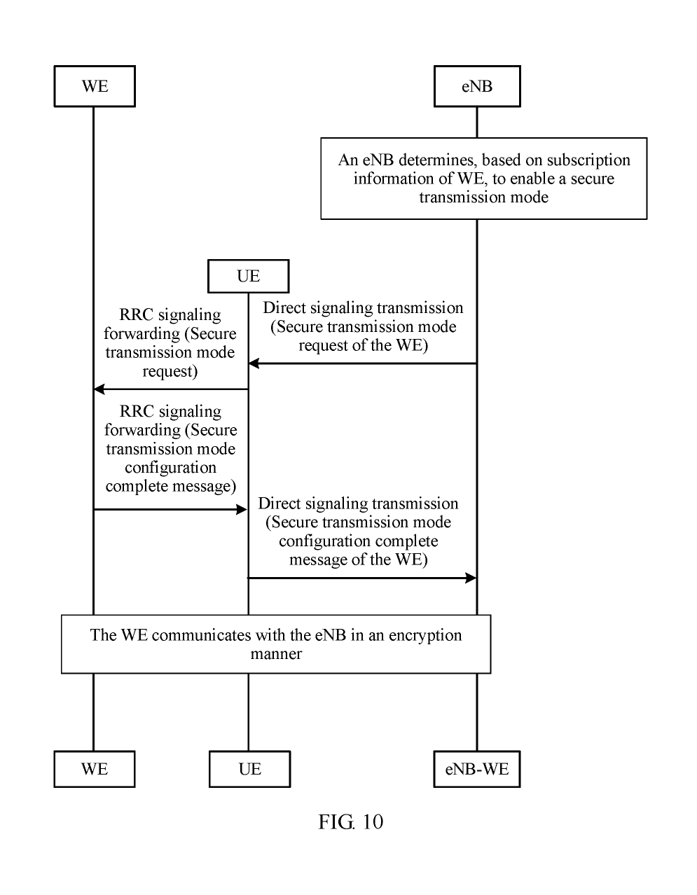

For one embodiment, FIG. 10 shows a security parameter transmission process.

In this embodiment, it is assumed that the second terminal device is WE, and the second terminal device is UE. A base station determines, based on subscription information of wearable equipment, that the wearable equipment is valid. After determining that a secure transmission mode needs to be enabled to communicate with the wearable equipment, the base station sends a secure transmission mode request to a first terminal device, and instructs the first terminal device to directly transmit the secure transmission mode request to the second terminal device. The first terminal device forwards the secure transmission mode request to the wearable equipment. After performing security configuration based on a security parameter carried in the secure transmission mode request, the wearable equipment returns a secure transmission mode configuration complete message to the first terminal device, and instructs the first terminal device to directly transmit the secure transmission mode configuration complete message to the base station. The base station receives the secure transmission mode configuration complete message directly transmitted by the first terminal device, and determines, based on the secure transmission mode configuration complete message, that the second terminal device has enabled the secure transmission mode. In this case, the base station and the second terminal device successfully negotiate the security parameter with each other, and may communicate with each other in an encryption manner.

For one embodiment, the first terminal device and the second terminal device can establish a wireless connection with each other by using a D2D protocol, a Bluetooth protocol, or a Wireless Fidelity Wi-Fi protocol.

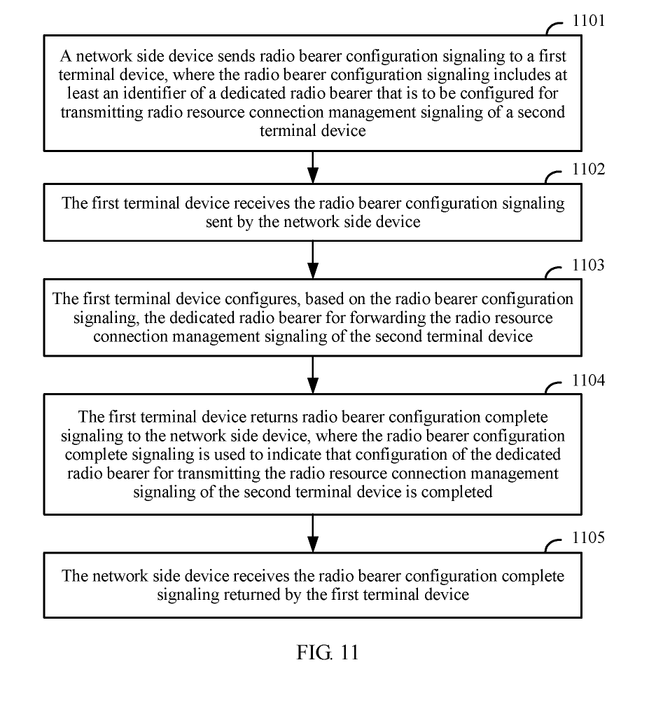

Based on a same application, another method for setting up a dedicated radio bearer for security parameter transmission is disclosed. The process of setting up a dedicated radio bearer between a network side device and a first terminal device is shown in FIG. 11 referring to Steps 1101 through 1105.

At Step 1101, a network side device sends radio bearer configuration signaling to a first terminal device, where the radio bearer configuration signaling includes at least an identifier of a dedicated radio bearer that is to be configured for transmitting radio resource connection management signaling of a second terminal device.

The radio bearer configuration signaling is used to configure a radio bearer between the network side device and the first terminal device.

For one embodiment, the network side device may configure a corresponding dedicated radio bearer for the second terminal device. For example, the dedicated radio bearer between the first terminal device and the network side device may be used to transmit signaling of a plurality of second terminal devices, or may be used to transmit signaling of one specific second terminal device.

For another embodiment, the radio bearer configuration signaling further includes one or a combination of the following information.

Relay indication information (relay indicator) that indicates that the configured dedicated radio bearer is used to relay data of the second terminal device, for example, relay signaling of the second terminal device.

A second terminal device identifier (remote UE ID) or a second terminal device identifier list (remote UE ID list) that indicates that the dedicated radio bearer may be used to transmit data of a second terminal device indicated by the second terminal device identifier or the second terminal device identifier list.

A configuration parameter of a radio link control (RLC) layer such that the parameter needs to keep the same as an RLC parameter of a common terminal.

MAC configuration information (MAC-config; MAC) that indicates a logical channel group (Logical channel group) of the dedicated radio bearer, for example, a logical channel identifier 5.

A temporary cell radio network temporary identifier (CRNTI) list such that when the second terminal device does not establish an RRC link to a network, and the second terminal device is linked with relay UE without obtaining an identifier allocated by the network, the relay UE allocates, based on the temporary CRNTI list, a temporary identifier to the second terminal device linked with the relay UE.

At Step 1102, the first terminal device receives the radio bearer configuration signaling sent by the network side device.

At Step 1103, the first terminal device configures, based on the radio bearer configuration signaling, the dedicated radio bearer for forwarding the radio resource connection management signaling of the second terminal device.

At Step 1104, the first terminal device returns radio bearer configuration complete signaling to the network side device, where the radio bearer configuration complete signaling is used to indicate that configuration of the dedicated radio bearer for transmitting the radio resource connection management signaling of the second terminal device is completed.

At Step 1105, the network side device receives the radio bearer configuration complete signaling returned by the first terminal device.

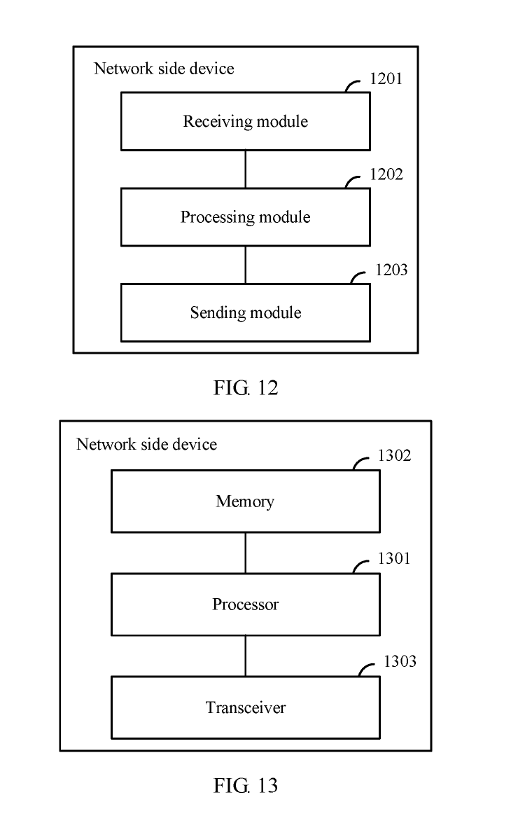

Based on a same application, for one embodiment, a network side device is disclosed in FIG. 12. The network side device includes a receiving module 1201, processing module 1202 and a sending module 1203. The receiving module 1201 is configured to receive radio resource connection management signaling sent by a first terminal device, wherein the first terminal device implements a relay function, and the radio resource connection management signaling is sent by a second terminal device to the first terminal device.

The processing module 1202 is configured to determine an identifier of the second terminal device that generates the radio resource connection management signaling received by the receiving module, and obtain a security parameter corresponding to the identifier of the second terminal device.

The sending module 1203 is configured to send the obtained security parameter to the second terminal device by using the first terminal device.

For one embodiment, the processing module 1202 is configured to:

determine an identifier of a dedicated radio bearer for transmitting the radio resource connection management signaling, and determine, based on a correspondence between an identifier of a dedicated radio bearer and an identifier of a second terminal device, that an identifier of a second terminal device corresponding to the identifier of the dedicated radio bearer for transmitting the radio resource connection management signaling is the identifier of the second terminal device that generates the radio resource connection management signaling, where the dedicated radio bearer is a radio bearer between the network side device and the first terminal device; or

obtain signaling source indication information carried in the radio resource connection management signaling, determine, based on the signaling source indication information, that the radio resource connection management signaling is generated by the second terminal device, and determine the identifier of the second terminal device based on the radio resource connection management signaling, where the signaling source indication information is used to indicate that the radio resource connection management signaling is generated by the second terminal device.

For one embodiment, the sending module 1203 is further configured to:

send radio bearer configuration signaling to the first terminal device before the receiving module receives the radio resource connection management signaling sent by the first terminal device, wherein the radio bearer configuration signaling includes at least the identifier of the dedicated radio bearer that is to be configured for transmitting the radio resource connection management signaling of the second terminal device; and

the receiving module 1201 is further configured to:

receive radio bearer configuration complete signaling returned by the first terminal device, wherein the radio bearer configuration complete signaling is used to indicate that configuration of the dedicated radio bearer for transmitting the radio resource connection management signaling of the second terminal device is completed.

For one embodiment, the processing module 1202 is configured to:

generate a secure transmission mode request, wherein the secure transmission mode request carries the security parameter; and

the sending module 1203 is specifically configured to:
send the secure transmission mode request generated by the processing module to the first terminal device, so that the first terminal device forwards the secure transmission mode request to the second terminal device.

For one embodiment, an attribute of a dedicated radio bearer carrying the secure transmission mode request includes the identifier of the second terminal device, the dedicated radio bearer is a radio bearer between the network side device and the first terminal device. The first terminal device forwards the secure transmission mode request to the second terminal device based on the identifier of the second terminal device included in the attribute of the dedicated radio bearer; or

the secure transmission mode request further carries the identifier of the second terminal device, and the first terminal device forwards the secure transmission mode request to the second terminal device based on the identifier of the second terminal device carried in the secure transmission mode request.

Based on a same application, for one embodiment, another network side device is shown in FIG. 13. The network side device includes a processor 1301, a memory 1302, and a transceiver 1303. The transceiver 1303 is configured to receive and send data under the control of the processor 1301. The memory 1302 stores a preset program, and the processor 1301 is configured to read the program stored in the memory 1302. For one embodiment, the processor 1301 is configured to perform the following process based on the program:

receiving, by using the transceiver 1303, radio resource connection management signaling sent by a first terminal device, where the first terminal device has a relay function, and the radio resource connection management signaling is sent by a second terminal device to the first terminal device;

determining an identifier of the second terminal device that generates the radio resource connection management signaling received by the transceiver 1303, and obtaining a security parameter corresponding to the identifier of the second terminal device; and

instructing the transceiver 1303 to send the obtained security parameter to the second terminal device by using the first terminal device. For one embodiment, the processor 1301 is configured to complete a function of the processing module 1202 of the network side device described herein. The transceiver 1303 is configured to complete, under the control of the processor 1301, functions of the receiving module 1201 and the sending module 1203 of the network side device described in the foregoing embodiment.

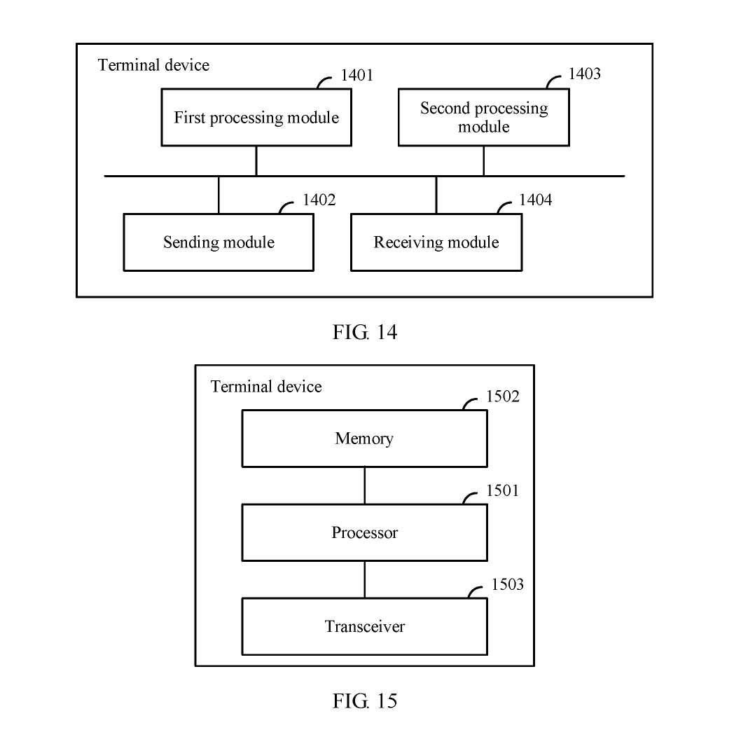

Based on a same application, for one embodiment, a terminal device is disclosed that is a first terminal device with a relay function as shown in FIG. 14. The terminal device includes a first processing module 1401, second processing module 1403, sending module 1402 and receiving module 1404.

The first processing module 1401 is configured to after it is determined that a destination of radio resource connection management signaling of a second terminal device is a network side device, instruct a sending module 1402 to send the radio resource connection management signaling to the network side device.

The second processing module 1403 is configured to receive, by using a receiving module 1404, a security parameter returned by the network side device based on the radio resource connection management signaling. The second processing module 1403 instructs the sending module 1402 to forward the security parameter to the second terminal device, wherein the security parameter is obtained by the network side device based on an identifier of the second terminal device after the network side device determines the identifier of the second terminal device that generates the radio resource connection management signaling.

For one embodiment, the first processing module 1401 is configured to if determining that the receiving module 1404 receives, by using a dedicated air interface resource, the radio resource connection management signaling sent by the second terminal device, determine that the destination of the radio resource connection management signaling is the network side device, where the dedicated air interface resource is used to instruct the first terminal device to forward signaling of the second terminal device to the network side device. For another embodiment, the first module 1401 is configured to determine that the radio resource connection management signaling carries forwarding instruction information, and determine, based on the forwarding instruction information, that the destination of the radio resource connection management signaling is the network side device, where the forwarding instruction information is used to instruct to forward signaling of the second terminal device to the network side device.

For one embodiment, the first processing module 1401 is configured to determine, based on a correspondence between an identifier of a second terminal device and an identifier of a dedicated radio bearer, an identifier of a dedicated radio bearer corresponding to the identifier of the second terminal device that generates the radio resource connection management signaling. The first processing module 1401 can instruct the sending module 1402 to send the radio resource connection management signaling to the network side device based on the identifier of the dedicated radio bearer, wherein the dedicated radio bearer is a radio bearer between the network side device and the first terminal device. For another embodiment, the first processing module 1401 after signaling source indication information is added to the radio resource connection management signaling, instruct the sending module 1402 to send the radio resource connection management signaling to the network side device, wherein the signaling source indication information is used to indicate that the radio resource connection management signaling is generated by the second terminal device.

For one embodiment, the first processing module 1401 is further configured to before determining, based on the correspondence between an identifier of a second terminal device and an identifier of a dedicated radio bearer, the identifier of the dedicated radio bearer corresponding to the identifier of the second terminal device that generates the radio resource connection management signaling, receive, by using the receiving module 1404, radio bearer configuration signaling sent by the network side device. The radio bearer configuration signaling includes at least the identifier of the dedicated radio bearer that is to be configured for transmitting the radio resource connection management signaling of the second terminal device

The first processing module 1401 is also configured after the dedicated radio bearer for forwarding the radio resource connection management signaling of the second terminal device is configured based on the radio bearer configuration signaling, instruct the sending module 1402 to return radio bearer configuration complete signaling to the network side device. The radio bearer configuration complete signaling is used to indicate that configuration of the dedicated radio bearer for transmitting the radio resource connection management signaling of the second terminal device is completed.

For one embodiment, the second processing module 1403 is configured to receive, by using the receiving module 1404, a secure transmission mode request returned by the network side device, where the secure transmission mode request carries the security parameter. The second module 1403 is configured to also instruct the sending module 1402 to forward the secure transmission mode request to the second terminal device.

For one embodiment, the second processing module 1403 is configured to determine the identifier of the second terminal device included in an attribute of a dedicated radio bearer carrying the secure transmission mode request, where the dedicated radio bearer is a radio bearer between the network side device and the first terminal device. The second module 1403 is configured to also forward, by using the sending module 1402, the secure transmission mode request to the second terminal device based on the identifier of the second terminal device included in the attribute of the dedicated radio bearer. The second module 1403 is also configured toif the secure transmission mode request further carries the identifier of the second terminal device, forward, by using the sending module 1402, the secure transmission mode request to the second terminal device based on the identifier of the second terminal device carried in the secure transmission mode request.

Based on a same application, for one embodiment, another terminal device is disclosed that is a first terminal device with a relay function as shown in FIG. 15. The terminal device includes a processor 1501, a memory 1502, and a transceiver 1503. The transceiver 1503 is configured to receive and send data under the control of the processor 1501. The memory 1502 stores a preset program. The processor 1501 is configured to read the program stored in the memory 1502, and perform the following process based on the program.

After it is determined that a destination of radio resource connection management signaling of a second terminal device is a network side device, the processor 1501 instructs the transceiver 1503 to send the radio resource connection management signaling to the network side device. The processor 1501 also receives, by using the transceiver 1503, a security parameter returned by the network side device based on the radio resource connection management signaling, and instructing the transceiver 1503 to forward the security parameter to the second terminal device. The security parameter is obtained by the network side device based on an identifier of the second terminal device after the network side device determines the identifier of the second terminal device that generates the radio resource connection management signaling.

For one embodiment, the processor 1501 is configured to complete functions of the first processing module 1401 and the second processing module 1403 of the first terminal device described herein. The transceiver 1503 is configured to complete, under the control of the processor 1501, functions of the receiving module 1404 and the sending module 1402 of the first terminal device described herein.

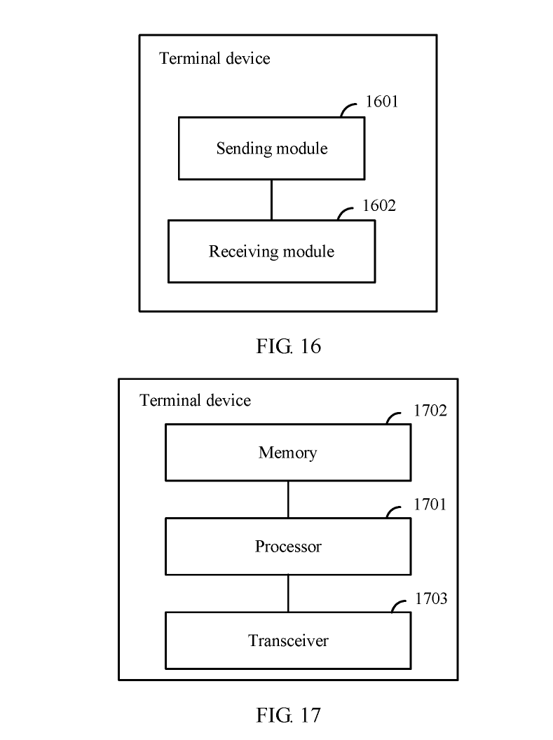

Based on a same application, for one embodiment, another terminal device is disclosed that is a second terminal device, that is, a remote device as shown in FIG. 16. The terminal device mainly includes a sending module 1601 and a receiving module 1602.

The sending module 1601 is configured to send radio resource connection management signaling to a first terminal device such that the first terminal device forwards the radio resource connection management signaling to a network side device after determining that a destination of the radio resource connection management signaling is the network side device. The the first terminal device implements a relay function.

The receiving module 1602 is configured to receive a security parameter returned by the network side device by using the first terminal device. The security parameter is obtained by the network side device based on an identifier of the terminal device after the network side device determines the identifier of the terminal device that generates the radio resource connection management signaling.

For one embodiment, the sending module 1601 is configured to send the radio resource connection management signaling to the first terminal device by using a dedicated air interface resource, where the dedicated air interface resource is used to instruct to forward signaling of the terminal device to the network side device. The sending module 1601 can also send the radio resource connection management signaling to the first terminal device after forwarding instruction information is added to the radio resource connection management signaling. The forwarding instruction information is used to instruct to forward signaling of the terminal device to the network side device.

Based on a same application, for one embodiment, another terminal device is disclosed that is a second terminal device, that is, a remote device as shown in FIG. 17. The terminal device includes a processor 1701, a memory 1702, and a transceiver 1703. The transceiver 1703 is configured to receive and send data under the control of the processor 1701. The memory 1702 stores a preset program. The processor 1701 is configured to read the program stored in the memory 1702, and perform the following process based on the program:

The processor 1701 sends radio resource connection management signaling to a first terminal device by using the transceiver 1703 such that the first terminal device forwards the radio resource connection management signaling to a network side device after determining that a destination of the radio resource connection management signaling is the network side device, where the first terminal device has a relay function.

The processor 1701 receives, by using the transceiver 1703, a security parameter returned by the network side device by using the first terminal device. The security parameter is obtained by the network side device based on an identifier of the terminal device after the network side device determines the identifier of the terminal device that generates the radio resource connection management signaling.

For one embodiment, the processor 1701 instructs the transceiver 1703 to send the radio resource connection management signaling to the first terminal device by using a dedicated air interface resource, where the dedicated air interface resource is used to instruct to forward signaling of the terminal device to the network side device. The processor 1701 also after forwarding instruction information is added to the radio resource connection management signaling, instructs the transceiver 1703 to send the radio resource connection management signaling to the first terminal device. The forwarding instruction information is used to instruct to forward signaling of the terminal device to the network side device.

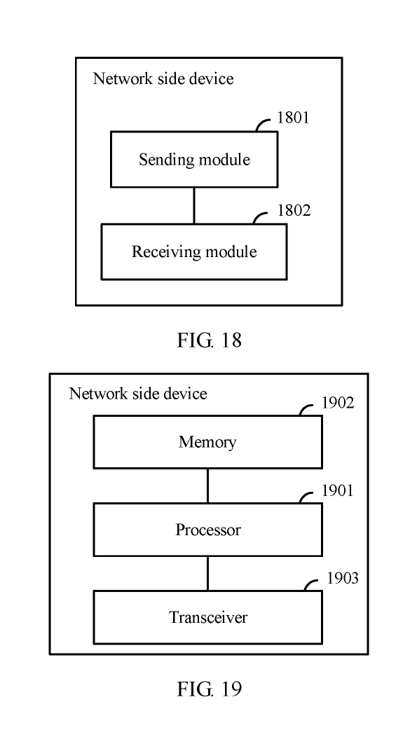

Based on a same application, for one embodiment another network side device is disclosed as shown in FIG. 18. The network side device includes a sending module 1801 and a receiving module 1802.

The sending module 1801 is configured to send radio bearer configuration signaling to a first terminal device. The radio bearer configuration signaling includes at least an identifier of a dedicated radio bearer that is to be configured for transmitting radio resource connection management signaling of a second terminal device. The dedicated radio bearer is a radio bearer between the network side device and the first terminal device, and the first terminal device implements a relay function.

The receiving module 1802 is configured to receive radio bearer configuration complete signaling returned by the first terminal device. The radio bearer configuration complete signaling is used to indicate that configuration of the dedicated radio bearer for transmitting the radio resource connection management signaling of the second terminal device is completed.

Based on a same application, for one embodiment, another network side device is disclosed as shown in FIG. 19. The network side device includes a processor 1901, a memory 1902, and a transceiver 1903. The transceiver 1903 is configured to receive and send data under the control of the processor 1901. The memory 1902 stores a preset program, and the processor 1901 is configured to read the program stored in the memory 1902, and perform the following process based on the program:

The processor 1901 instructs the transceiver 1903 to send radio bearer configuration signaling to a first terminal device. The radio bearer configuration signaling includes at least an identifier of a dedicated radio bearer that is to be configured for transmitting radio resource connection management signaling of a second terminal device. The dedicated radio bearer is a radio bearer between the network side device and the first terminal device, and the first terminal device has a relay function; and

The processor 1901 also instructs the transceiver 1903 to receive radio bearer configuration complete signaling returned by the first terminal device, where the radio bearer configuration complete signaling is used to indicate that configuration of the dedicated radio bearer for transmitting the radio resource connection management signaling of the second terminal device is completed.

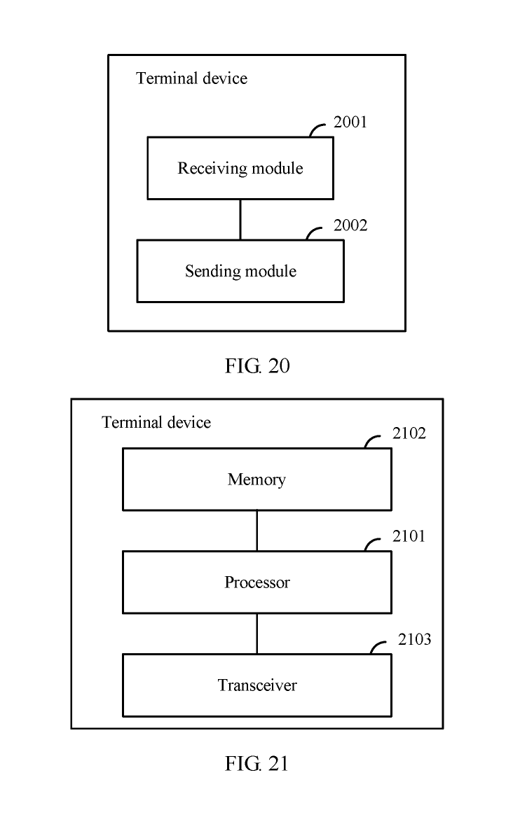

Based on a same application, for one embodiment, another terminal device is disclosed that is a first terminal device with a relay function as shown in FIG. 20. The terminal device includes a receiving module 2001 and sending module 2002.

The receiving module 2001 is configured to receive radio bearer configuration signaling sent by a network side device. The radio bearer configuration signaling includes at least an identifier of a dedicated radio bearer that is to be configured for transmitting radio resource connection management signaling of a second terminal device. The dedicated radio bearer is a radio bearer between the network side device and the first terminal device.

The sending module 2002 is configured to return radio bearer configuration complete signaling to the network side device after the dedicated radio bearer for forwarding the radio resource connection management signaling of the second terminal device is configured based on the radio bearer configuration signaling.

The radio bearer configuration complete signaling is used to indicate that configuration of the dedicated radio bearer for transmitting the radio resource connection management signaling of the second terminal device is completed.

Based on a same application, for one embodiment, another terminal device is disclosed that is a first terminal device with a relay function as shown in FIG. 21. The terminal device includes a processor 2101, a memory 2102, and a transceiver 2103. The transceiver 2103 is configured to receive and send data under the control of the processor 2101. The memory 2102 stores a preset program, and the processor 2101 is configured to read the program stored in the memory 2102, and perform the following process based on the program.

The processor 201 receives, by using the transceiver 2103, radio bearer configuration signaling sent by a network side device. The radio bearer configuration signaling includes at least an identifier of a dedicated radio bearer that is to be configured for transmitting radio resource connection management signaling of a second terminal device. The dedicated radio bearer is a radio bearer between the network side device and the first terminal device.

The processor 201, after the dedicated radio bearer for forwarding the radio resource connection management signaling of the second terminal device is configured based on the radio bearer configuration signaling, instructs the transceiver 2103 to return radio bearer configuration complete signaling to the network side device. The radio bearer configuration complete signaling is used to indicate that configuration of the dedicated radio bearer for transmitting the radio resource connection management signaling of the second terminal device is completed.

For the embodiments of FIG. 13, FIG. 15, FIG. 17, FIG. 19, and FIG. 21, the processor, the memory, and the transceiver are connected to each other by using a bus. A bus architecture may include any quantity of interconnected buses and bridges, and specifically links together various circuits of one or more processors represented by the processor and a memory represented by the memory. The bus architecture may further link together various other circuits such as a peripheral device, a voltage regulator, and a power management circuit, and this is well known in the art. Therefore, no further description is provided in this specification. A bus interface provides an interface. The transceiver may be a plurality of components, that is, the transceiver includes a transmitter and a transceiver, and provides a unit configured to communicate with various other apparatuses on a transmission medium. The processor is responsible for bus architecture management and general processing. The memory may store data used when the processor performs an operation.

Based on the foregoing detailed description, after receiving, by using the first terminal device with a relay function, the radio resource connection management signaling that is used to request to obtain the security parameter, the network side device can determine the identifier of the second terminal device that generates the radio resource connection management information. The network side device also obtains the security parameter corresponding to the identifier of the second terminal device, and sends the obtained security parameter to the second terminal device by using the first terminal device. In this way, the network side device configures the security parameter for the second terminal device in a manner of forwarding signaling by using the first terminal device.

The disclosed embodiments may be provided as a method, a system, or a computer program product, can use a form of hardware only embodiments, software only embodiments, or embodiments with a combination of software and hardware. Moreover, the embodiments may use a form of a computer program product that is implemented on one or more computer-usable storage media (including but not limited to a disk memory, an optical memory, and the like) that include computer-usable program code.

The present embodiments are described with reference to the flowcharts and/or block diagrams of the method, the device (system), and the computer program product according to the embodiments described herein.

It should be understood that computer program instructions may be used to implement each process and/or each block in the flowcharts and/or the block diagrams, and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specified function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Various modifications and variations to the present embodiments can be made without departing from the spirit and scope of the present embodiments. The present embodiments are intended to cover these modifications and variations falling within the scope of appended claims.

What is claimed is:

1. A communication method, comprising:
receiving, by a network side device, radio resource connection management signaling sent by a first terminal device, wherein the first terminal device implements a relay function, and the radio resource connection management signaling is sent by a second terminal device to the first terminal device;
determining, by the network side device, an identifier of the second terminal device that generates the radio resource connection management signaling, and obtaining a security parameter corresponding to the identifier of the second terminal device; and
sending, by the network side device, the obtained security parameter to the second terminal device by using the first terminal device.

2. The method according to claim 1, wherein the radio resource connection management signaling includes the identifier of the second terminal device.

3. The method according to claim 1, wherein the determining, by the network side device, an identifier of the second terminal device that generates the radio resource connection management signaling comprises:
determining, by the network side device, an identifier of a dedicated radio bearer for transmitting the radio resource connection management signaling, and determining, based on a correspondence between an identifier of a dedicated radio bearer and an identifier of a second terminal device, that an identifier of a second terminal device corresponding to the identifier of the dedicated radio bearer for transmitting the radio resource connection management signaling is the identifier of the second terminal device that generates the radio resource connection management signaling, wherein the dedicated radio bearer is a radio bearer between the network side device and the first terminal device; or
obtaining, by the network side device, signaling source indication information carried in the radio resource connection management signaling, determining, based on the signaling source indication information, that the radio resource connection management signaling is generated by the second terminal device, and determining the identifier of the second terminal device based on the radio resource connection management signaling, wherein the signaling source indication information is used to indicate that the radio resource connection management signaling is generated by the second terminal device.

4. The method according to claim 3, wherein before the receiving, by a network side device, radio resource connection management signaling sent by a first terminal device, the method further comprises:
sending, by the network side device, radio bearer configuration signaling to the first terminal device, wherein the radio bearer configuration signaling comprises at least the identifier of the dedicated radio bearer that is to be configured for transmitting the radio resource connection management signaling of the second terminal device; and
receiving, by the network side device, radio bearer configuration complete signaling returned by the first terminal device, wherein the radio bearer configuration complete signaling is used to indicate that configuration of the dedicated radio bearer for transmitting the radio resource connection management signaling of the second terminal device is completed.

5. The method according to claim 1, wherein the sending, by the network side device, the obtained security parameter to the second terminal device by using the first terminal device comprises:
generating, by the network side device, a secure transmission mode request, wherein the secure transmission mode request carries the security parameter; and
sending, by the network side device, the secure transmission mode request to the first terminal device, so that the first terminal device forwards the secure transmission mode request to the second terminal device.

6. A communication method comprising:
determining, by a first terminal device, that a destination of radio resource connection management signaling of a second terminal device is a network side device, and then sending the radio resource connection management signaling to the network side device, wherein the first terminal device has a relay function; and
receiving, by the first terminal device, a security parameter returned by the network side device based on the radio resource connection management signaling, and forwarding the security parameter to the second terminal device, wherein the security parameter is obtained by the network side device based on an identifier of the second terminal device after the network side device determines the identifier of the second terminal device that generates the radio resource connection management signaling.

7. The method according to claim 6, wherein the radio resource connection management signaling carries the identifier of the second terminal device.

8. The method according to claim 6, wherein the determining, by a first terminal device, that a destination of radio resource connection management signaling of a second terminal device is a network side device comprises:
if determining to receive, by using a dedicated air interface resource, the radio resource connection management signaling sent by the second terminal device, determining, by the first terminal device, that the destination of the radio resource connection management signaling is the network side device, wherein the dedicated air interface resource is used to instruct the first terminal device to forward signaling of the second terminal device to the network side device; or
determining, by the first terminal device, that the radio resource connection management signaling carries forwarding instruction information, and determining, based on the forwarding instruction information, that the destination of the radio resource connection management signaling is the network side device, wherein the forwarding instruction information is used to instruct to forward signaling of the second terminal device to the network side device.

9. The method according to claim 6, wherein the sending, by a first terminal device, the radio resource connection management signaling to the network side device comprises:
determining, by the first terminal device based on a correspondence between an identifier of a second terminal device and an identifier of a dedicated radio bearer, an identifier of a dedicated radio bearer corresponding to the identifier of the second terminal device that generates the radio resource connection management signaling, and sending the radio resource connection management signaling to the network side device based on the identifier of the dedicated radio bearer, wherein the dedicated radio bearer is a radio bearer between the network side device and the first terminal device; or
sending, by the first terminal device, the radio resource connection management signaling to the network side device after adding signaling source indication information to the radio resource connection management signaling, wherein the signaling source indication information is used to indicate that the radio resource connection management signaling is generated by the second terminal device.

10. The method according to claim 6, wherein the receiving, by the first terminal device, a security parameter returned by the network side device based on the radio resource connection management signaling, and forwarding the security parameter to the second terminal device comprises:
receiving, by the first terminal device, a secure transmission mode request returned by the network side device, wherein the secure transmission mode request carries the security parameter; and
forwarding, by the first terminal device, the secure transmission mode request to the second terminal device.

11. A network side device comprising:
a receiver, configured to receive radio resource connection management signaling sent by a first terminal device, wherein the first terminal device has a relay function, and the radio resource connection management signaling is sent by a second terminal device to the first terminal device;
a processor, configured to: determine an identifier of the second terminal device that generates the radio resource connection management signaling received by the receiving module, and obtain a security parameter corresponding to the identifier of the second terminal device; and
a transmitter, configured to send the obtained security parameter to the second terminal device by using the first terminal device.

12. The network side device according to claim 11, wherein the radio resource connection management signaling carries the identifier of the second terminal device.

13. The network side device according to claim 11, wherein the processor is specifically configured to:
determine an identifier of a dedicated radio bearer for transmitting the radio resource connection management signaling, and determine, based on a correspondence between an identifier of a dedicated radio bearer and an identifier of a second terminal device, that an identifier of a second terminal device corresponding to the identifier of the dedicated radio bearer for transmitting the radio resource connection management signaling is the identifier of the second terminal device that generates the radio resource connection management signaling, wherein the dedicated radio bearer is a radio bearer between the network side device and the first terminal device; or
obtain signaling source indication information carried in the radio resource connection management signaling, determine, based on the signaling source indication information, that the radio resource connection management signaling is generated by the second terminal device, and determine the identifier of the second terminal device based on the radio resource connection management signaling, wherein the signaling source indication information is used to indicate that the radio resource connection management signaling is generated by the second terminal device.

14. A terminal device comprises:
a first processor, configured to: after it is determined that a destination of radio resource connection management signaling of a second terminal device is a network side device, instruct a sending module to send the radio resource connection management signaling to the network side device; and
a second processor, configured to: receive, by using a receiving module, a security parameter returned by the network side device based on the radio resource connection management signaling, and instruct the sending module to forward the security parameter to the second terminal device, wherein the security parameter is obtained by the network side device based on an identifier of the second terminal device after the network side device determines the identifier of the second terminal device that generates the radio resource connection management signaling.

15. The terminal device according to claim 14, wherein the radio resource connection management signaling carries the identifier of the second terminal device.

16. The terminal device according to claim 14, wherein the first processor is specifically configured to:
if determining that the receiving module receives, by using a dedicated air interface resource, the radio resource connection management signaling sent by the second terminal device, determine that the destination of the radio resource connection management signaling is the network side device, wherein the dedicated air interface resource is used to instruct the first terminal device to forward signaling of the second terminal device to the network side device; or
determine that the radio resource connection management signaling carries forwarding instruction information, and determine, based on the forwarding instruction information, that the destination of the radio resource connection management signaling is the network side device, wherein the forwarding instruction information is used to instruct to forward signaling of the second terminal device to the network side device.

17. The terminal device according to claim 14, wherein the first processor is specifically configured to:
determine, based on a correspondence between an identifier of a second terminal device and an identifier of a dedicated radio bearer, an identifier of a dedicated radio bearer corresponding to the identifier of the second terminal device that generates the radio resource connection management signaling, and instruct the sending module to send the radio resource connection management signaling to the network side device based on the identifier of the dedicated radio bearer, wherein the dedicated radio bearer is a radio bearer between the network side device and the first terminal device; or
after signaling source indication information is added to the radio resource connection management signaling, instruct the sending module to send the radio resource connection management signaling to the network side device, wherein the signaling source indication information is used to indicate that the radio resource connection management signaling is generated by the second terminal device.

18. The terminal device according to claim 17, wherein the first processor is further configured to:
before determining, based on the correspondence between an identifier of a second terminal device and an identifier of a dedicated radio bearer, the identifier of the dedicated radio bearer corresponding to the identifier of the second terminal device that generates the radio resource connection management signaling, receive, by using the receiving module, radio bearer configuration signaling sent by the network side device, wherein the radio bearer configuration signaling comprises at least the identifier of the dedicated radio bearer that is to be configured for transmitting the radio resource connection management signaling of the second terminal device; and
after the dedicated radio bearer for forwarding the radio resource connection management signaling of the second terminal device is configured based on the radio bearer configuration signaling, instruct the sending module to return radio bearer configuration complete signaling to the network side device, wherein the radio bearer configuration complete signaling is used to indicate that configuration of the dedicated radio bearer for transmitting the radio resource connection management signaling of the second terminal device is completed.

19. The terminal device according to claim 14, wherein the second processing module is specifically configured to:
receive, by using the receiving module, a secure transmission mode request returned by the network side device, wherein the secure transmission mode request carries the security parameter; and
instruct the sending module to forward the secure transmission mode request to the second terminal device.

20. The terminal device according to claim 19, wherein the second processor is specifically configured to:
determine the identifier of the second terminal device comprised in an attribute of a dedicated radio bearer carrying the secure transmission mode request, wherein the dedicated radio bearer is a radio bearer between the network side device and the first terminal device; and forward, by using the sending module, the secure transmission mode request to the second terminal device based on the identifier of the second terminal device comprised in the attribute of the dedicated radio bearer; or
if the secure transmission mode request further carries the identifier of the second terminal device, forward, by using the sending module, the secure transmission mode request to the second terminal device based on the identifier of the second terminal device carried in the secure transmission mode request.
